(19) United States
(12) Patent Application Publication
(10) Pub. No.: US 2003/0149916 A1
(43) Pub. Date: Aug. 7, 2003

(54) Fault verification apparatus

(76) Inventors: Hideyuki Ohtake, Hyogo (JP); Yoshikazu Akamatsu, Hyogo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/208,859

(22) Filed: Aug. 1, 2002

(30) Foreign Application Priority Data
Feb. 6, 2002 (JP) 2002-29776

(51) Int. Cl. H02H 3/05

(52) U.S. Cl. 714/33

(57) ABSTRACT

A fault verification apparatus performs a logic simulation of a circuit having a normal delay and a logic simulation of a circuit in which delay is intentionally changed for a node and compares the simulation results at a specific time and checks whether or not a test pattern can detect a fault due to a delay abnormality. The apparatus performs the logic simulation by applying the test pattern to the normal circuit and a variety of fault types and compares the expected values obtained from the results of the respective logic simulations and verifies whether or not the test pattern can detect the delay fault by whether or not the expected values are different from each other at a specific comparison point.

### BACKGROUND OF THE INVENTION

1. Field of the Invention

The present invention relates to a fault verification apparatus, a method of verifying a fault, and a technique of analyzing a fault, which verify the reliability of a test pattern used for a shipping test of a semiconductor circuit such as LSI and the like.

2. Description of Related Art

First of all, a fault verification apparatus or fault simulator will be described. This fault verification apparatus is a quality checking apparatus for checking the extent to which an input vector (test pattern) for a shipping test can select a failed LSI in a test (checking operation) conducted on LSIs before shipment.

FIG. 33 is a block diagram showing a conventional fault verification apparatus. In FIG. 33, reference numeral 101 denotes a fault verification apparatus that checks the quality of a test pattern; numeral 102 denotes a net list that is logic connection information of an LSI circuit inputted to the fault verification apparatus 101; numeral 103 denotes a fault-generated point list file for specifically describing which circuit is to be verified for a fault; numeral 104 denotes a test pattern that is input information to operate the LSI circuit; numeral 105 denotes a fault detection report file obtained by checking the net list 102, fault-generated point list file 103 and test pattern 104 by use of the fault verification apparatus 101.

Next, a specific operation flow of the fault verification apparatus will be described with reference to the drawings.

FIG. 34 is an operation flow of the conventional fault verification apparatus. First, in step ST101 and step ST102, a fault-generated point is drawn from the net list 102 that is the connection information of an LSI circuit to generate the fault-generated point list file 103. The fault point generated in this manner is called the “0”, “1” Stuck-At fault model (Stuck-At-0 and Stuck-AT-1), which will be described later. Next, in step ST103 is performed a logic simulation. This logic simulation is a simulation of a normal circuit to which a fault is not given. Further, in step ST104, the simulation results obtained in step ST103 is held as an expected value of the normal circuit in the fault verification apparatus 101. Next, in step ST105 and step ST106, a logic simulation is performed by giving a virtual fault to the LSI. A virtual fault model in this case is the “0”, “1” Stuck-AT fault model and the simulation results is held in the fault verification apparatus 101. In the next step ST107, the simulation results obtained in steps ST104 and ST106 are compared with each other. If the simulation results are different from each other, in the case where a fault is found, the fault can be found by a target test pattern, whereby it can be checked that the quality of the test pattern is good. The steps from ST105 to ST108 are performed for each fault point, and the final step ST109 is performed until the fault point not checked yet is not present, that is, the final step ST109 is a step for judging whether or not a fault check is performed for all the circuits and, if necessary, continuing the fault check.

Next, the fault model will be described. The causes of fault of the LSI are mainly, (a) a “0”, “1” Stuck-At fault in which the LSI is put into contact with a power source path, (b) a delay fault causing an abnormal operation because of the abnormality in operating timing of the circuit, and (c) other faults (bridge fault and the like). As to (a) the Stuck-At faults, as shown in FIG. 35, the “0”, “1” Stuck-At fault is a symptom in which any one point of the LSI circuit develops a short circuit with a power source or a ground to occur an inconvenience.

Incidentally, in a conventional LSI manufacturing process, many faults can be checked by this fault model, but in a recent fine patterning process, (b) the delay fault increases because of a wiring delay and the like.

Next, FIG. 36 is an illustration of a conventional technique for analyzing a fault. In FIG. 36, reference numeral 101 denotes a fault verification apparatus that checks the quality of a test pattern, thus verifying “0”, “1” Stuck-At faults; numeral 102 denotes a net list that is the logic connection information of the LSI circuit inputted to the fault verification apparatus 101; numeral 104 denotes a test pattern that is input information to operate the LSI circuit; numeral 105 denotes a fault detection report file including the information such as detection pin, detecting time, detected value, and fault point Stuck-At value which is obtained by the fault simulation of the fault verification apparatus 101; numeral 106 denotes a fault generation program; numeral 112 denotes a semiconductor circuit such as an LSI; numeral 111 denotes a tester; numeral 109 denotes a detection state report file including the information such as the detection pin, detecting time, and detected value which is obtained by various kinds of circuit tests of the tester 111; numeral 108 denotes a condition comparing section for comparing a predetermined condition; and numeral 110 denotes a comparison result file including the information of the detection pin, detecting time, detected value, and fault point Stuck-At value which is obtained by the condition comparing section 108.

Next, the operation flow of this technique of analyzing a fault will be described.

The fault verification apparatus 101 receives the logic connection information of the LSI circuit from the net list 102, performs a fault simulation on the basis of the test pattern 104 by use of a variety of “0”, “1” Stuck-At fault models, compares the simulation results with those of a normal circuit, and stores the comparison results in the fault detection report file 105. On the other hand, similarly, the tester 111 judges the pass/fail of an LSI circuit 112 on the basis of the test pattern 104 and stores the results in the detection state report file 109. The condition comparing section 108 compares the conditions of the detection pin, detecting time, detected value and the like between the fault detection report file 105 and the test report file 109, and analyzes a fault point caused by the “0”, “1” Stuck-At faults and stores the analysis results in the comparison result file 110. In this manner, it is possible to specify the fault point caused by the “0”, “1” Stuck-At fault.

Since the conventional fault analysis apparatus and technique for analyzing a fault are constituted in the above manner, they present the following drawback: as high-speed operation and fine patterns of the LSI are developed, in addition to the “0”, “1” Stuck-At faults, the delay faults due to timing abnormalities increase in number; however, since a fault model relating to the delay fault can not be produced, the conventional apparatus and technique don't have sufficient functions to verify the faults of a semiconductor circuit such as LSI developed through recent fine patterning processes. To be more specific, since an existing function fault simulator can perform only a verification corresponding to the “0”, “1” Stuck-At fault model, there is a problem that the simulator cannot verify the quality of the test pattern, i.e., whether faults due to delay abnormality can be detected or not.

### SUMMARY OF THE INVENTION

Since the present invention has been made to solve the aforementioned problem, it is an object of the present invention to provide a fault verification apparatus, a method of verifying a fault, and a technique of analyzing a fault in which the quality of a test pattern can be verified whether the test pattern can detect a fault to be caused by delay, thus specifying and locating the fault point.

According to a first aspect of the present invention, there is provided a fault verification apparatus including: a unit for drawing a fault point from circuit information; a unit for performing a logic simulation through a normal circuit by a test pattern and defining the simulation results as a first expected value; a unit for specifying a fault-generated point from the fault point and generating a predetermined delay fault and inserting the delay fault at the fault-generated point to produce a fault circuit; a unit for performing a logic simulation through the fault circuit by the test pattern and defining the simulation results as a second expected value; and a unit for comparing the first expected value with the second expected value at a specific time.

Therefore, the timing of a signal which passes the fault point is advanced or delayed to produce appropriately the second expected value involving an increase or decrease of delay and the second expected value is compared with the first expected value of the normal circuit. This makes it possible to judge whether or not the test pattern can detect the fault due to a delay abnormality, thereby improving the evaluation of reliability of the test pattern.

According to a second aspect of the present invention, there is provided a method of verifying a fault including the steps of: drawing a fault point from circuit information; performing a logic simulation through a normal circuit by a test pattern and defining the simulation results as a first expected value; specifying a fault-generated point from the fault point and generating a predetermined delay fault and inserting the delay fault at the fault-generated point to produce a fault circuit; performing a logic simulation through the fault circuit by the test pattern and defining the simulation results as a second expected value; comparing the first expected value through the normal circuit with the second expected value through the fault circuit at a specific time; and verifying the next fault point after the verification of a delay value within a predetermined range at the specified fault-generated point is completed.

Therefore, the timing of a signal which passes the fault point is advanced or delayed to produce the second expected value involving an increase or a decrease of delay and the second expected value is compared with the first expected value of the normal circuit. This makes it possible to judge whether or not the test pattern can detect the fault due to a delay abnormality, thereby improving the evaluation of reliability of the test pattern.

According to a third aspect of the present invention, there is provided a technique of analyzing a fault including the steps of: drawing the information of a detecting time of a delay fault, a detection pin, a detected value, a fault point, an abnormal delay value from the result of a fault simulation in which a delay fault is taken into account in the aforementioned apparatus of verifying delay faults; and specifying the fault point caused by the delay fault.

Therefore, it is possible to specify the fault point of a semiconductor circuit caused by the delay fault.

### BRIEF DESCRIPTION OF THE DRAWINGS

FIG. 1 is a block diagram showing a fault verification apparatus in accordance with an embodiment 1 of the present invention;

FIG. 2 is an illustration showing specific examples of delay faults;

FIG. 3 is a fault checking flow of the fault verification apparatus in accordance with the embodiment 1 of the present invention;

FIG. 4 is an illustration to show modifications of delay to be verified;

FIG. 5 is an illustration to show an example of causing a fault in which the delay of an output port increases;

FIG. 6 is an illustration to show an example of causing a fault in which the delay of an input port increases;

FIG. 7 is an illustration to show an example of causing a fault in which the delay of a net increases;

FIG. 8 is an illustration to show an example of causing a fault in which the delay of a net increases;

FIG. 9 is an illustration to show an example of causing a fault in which the delay of a net increases;

FIG. 10 is an illustration to show an example of checking a delay fault in which delay increases;

FIG. 11 is an illustration to show an example of causing a delay fault in which delay decreases;

FIG. 12 is an illustration to show an example of causing a delay fault in which the delay of an output port decreases;

FIG. 13 is an illustration to show an example of causing a delay fault in which the delay of an input port decreases;

FIG. 14 is an illustration to show an example of causing a delay fault in which the delay of a net which is not branched decreases;

FIG. 15 is an illustration to show an example of causing a delay fault in which the delay of a net branched decreases;

FIG. 16 is an illustration to show an example of causing a delay fault in which the delay of a net converged decreases;

FIG. 17 is an illustration to show an example of causing a delay fault in which delay decreases;

FIG. 18 is an illustration to show an example of causing a delay fault in which the delay of an input port decreases;

FIG. 19 is an illustration to show an example of causing a delay fault in which the delay of a net decreases;

FIG. 20 is an illustration to show an example of causing a delay fault in which the delay of a net to which a plurality of inputs are connected decreases;

FIG. 21 is an illustration to show an example of causing a delay fault in which the delay of a net to which a plurality of outputs are connected decreases;

FIG. 22 is an illustration to show an example of causing a delay fault in which the delay of a net to which a plurality of inputs and a plurality of outputs are connected decreases;

FIG. 23 is an illustration to show an example of causing a delay fault in which the delay of a net to which a plurality of inputs and a plurality of outputs are connected decreases;

FIG. 24 is an illustration to show an example of causing a delay fault in which the delay of a net to which a plurality of inputs and a plurality of outputs are connected decreases;

FIG. 25 is an illustration to show an example of causing a delay fault in which the delay of a net to which a plurality of inputs and a plurality of outputs are connected decreases;

FIG. 26 is an illustration to show an example of causing a delay fault in which the delay of a net to which a plurality of inputs and a plurality of outputs are connected decreases;

FIG. 27 is a fault checking flow of a fault verification apparatus in accordance with an embodiment 2 of the present invention;

FIG. 28 is a circuit diagram to show a critical path;

FIG. 29 is an illustration to show an example of an equivalent fault of a timing fault;

FIG. 30 is an illustration to show a fault analysis technique in accordance with the preferred embodiment 2 of the present invention;

FIG. 31 is an illustration to show a checking example 1;

FIG. 32 is an illustration to show a checking example 2;

FIG. 33 is a block diagram to show a conventional fault verification apparatus;

FIG. 34 is an operation flow of the conventional fault verification apparatus;

FIG. 35 is an illustration of a “0”, “1” Stuck-At fault; and

FIG. 36 is an illustration of a conventional technique of analyzing a fault.

### DETAILED DESCRIPTION OF THE PREFERRED EMBODIMENTS

An embodiment of the present invention will be described below.

Embodiment 1

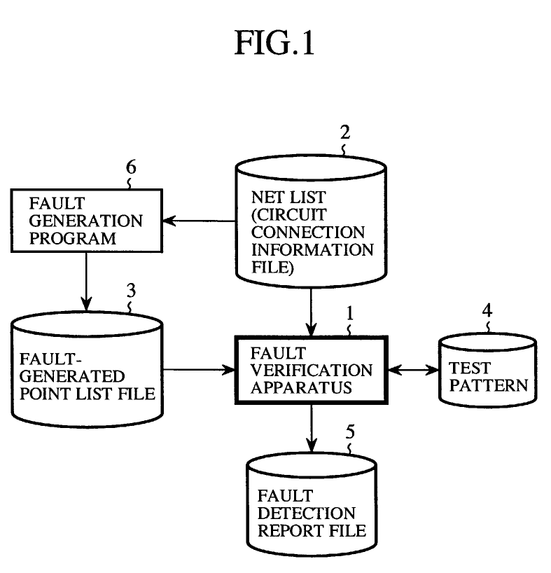

FIG. 1 is a block diagram showing a fault verification apparatus showing in accordance with an embodiment 1 of the present invention. In FIG. 1, reference numeral 1 denotes a fault verification apparatus that checks the quality of a test pattern corresponding to a delay fault; numeral 2 denotes a net list that is logic connection information of an LSI circuit inputted to the fault verification apparatus 1; numeral 3 denotes a fault-generated point list file that specifically describes which circuit is to be checked for a fault; numeral 4 denotes a test pattern that is input information to operate the LSI circuit; numeral 5 denotes a fault detection report file obtained by verifying the net list 2, fault-generated point list file 3 and test pattern 4 by use of the fault verification apparatus 1; and numeral 6 denotes a fault generation program.

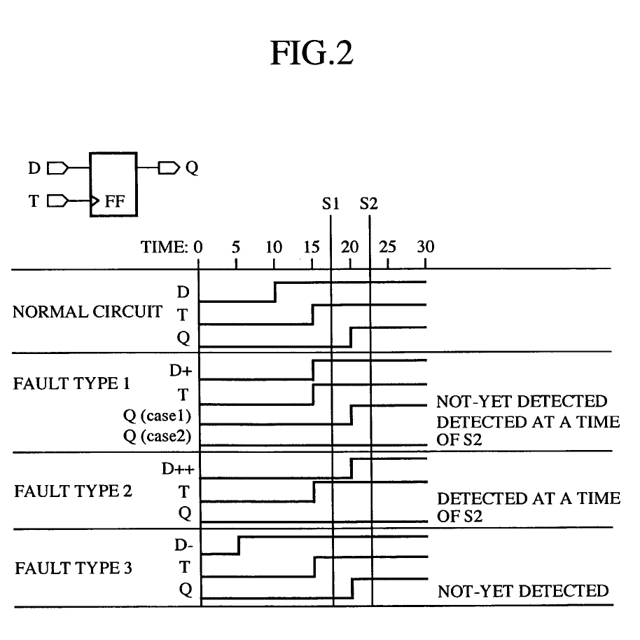

FIG. 2 shows specific examples of delay faults and shows a simple circuit called FF (flip-flop) and timing charts. In the circuit shown in FIG. 2, reference character D denotes a data signal, character T denotes a clock signal, and character Q denotes an output signal. It is a fault type 1, a fault type 2, and a fault type 3 that show the cases where a timing when the data signal D is inputted is advanced or delayed on a time axis due to some causes. Incidentally, in the timing chart in FIG. 2, reference symbols S1 and S2 each denote a comparison point of an expected value; pin name+denotes a normal delay of+5 time unit; pin name++denotes a normal delay of+10 time unit; pin name−denotes a normal delay of−5 time unit; pin name—denotes a normal delay of−10 time unit; and ditto in the following.

Usually, a semiconductor circuit such as an LSI is not constituted only by a FF. Thus, assuming that another circuit is provided on the downstream side of the FF, a signal exerting a malfunction on the whole circuit is the output signal Q. In this example, assume that if the output signal operates in the same way between the times S1 and S2 as in the normal circuit, an abnormal operation does not occur.

In the fault type 1, because the input signal D delays by 5 time units (time unit in simulation), the output signal Q is unchanged and thus a malfunction occurs.

Also in the fault type 2, because the input signal D delays by 10 time units, a malfunction occurs.

In the fault type 3, the input signal D is inputted earlier by 5 time units but the output signal Q changes between the times S1 and S2 and thus the circuit operates normally. In this manner, when the timing changes, in many cases, the circuit does not operates normally, and therefore, a fault verification apparatus capable of checking a delay fault is required.

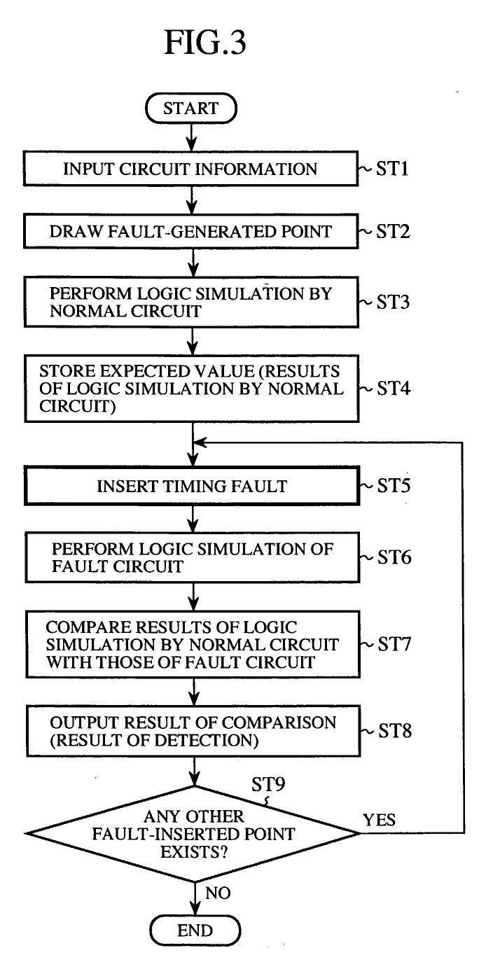

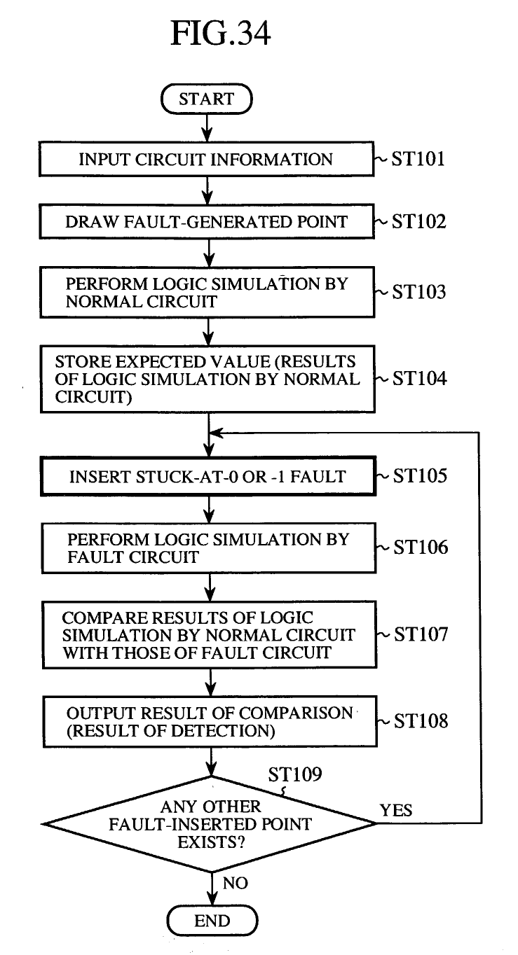

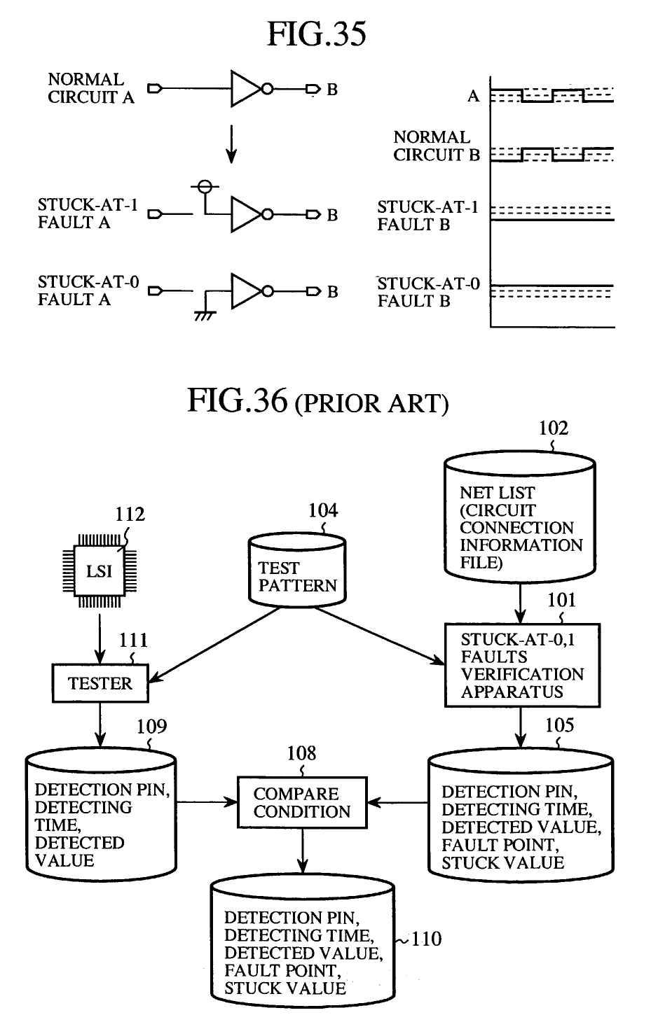

The present invention to provide a fault verification apparatus 1 characterized by handling a delay fault that cannot be treated by a conventional fault verification apparatus. FIG. 3 shows a fault checking flow in accordance with the embodiment 1 of the present invention. According to this fault checking flow, the present invention is characterized in that a fault inserted by a fault causing section (step ST5) is a delay fault model, and is different in the steps ST2 to ST8 from the fault checking flow in the related art (see FIG. 34).

Referring to the feature of the embodiment 1, the fault verification apparatus verifies whether or not a test pattern can detect a fault due to delay abnormality by performing a logic simulation of a normal circuit and a logic simulation of a circuit in which delay is intentionally changed at a node, and by comparing the simulation results at a specific time between the two circuits. To be more specific, a test pattern is applied to the normal circuit and the fault types 1 to 3, and the expected values obtained from the respective results of logic simulation are compared with each other, and it is checked to see whether or not the test pattern can detect the delay fault by checking whether or not the results of comparison of the expected values at the specified comparison points are different from each other.

The flow of checking the quality of the test pattern will be described in the following.

(1) Method of Increasing or Decreasing Delay

When a check of one fault point is made by changing delay by a specified amount of change in a specified range and is completed for a delay value within the specified range, a check of the next fault point is made by changing delay in the same manner. The range of increase or decrease of the delay is designated arbitrarily by a user. The amount of change (increase or decrease) of the delay per one operation is within a range of increase or decrease of the delay value specified by the user in accordance with a minimum simulation accuracy (see specific examples shown in FIG. 6 and the like).

(2) Method of Distributing a Delay Fault

The fault verification apparatus 1 distributes a delay fault to all the gates and nodes. Further, if a path delay can be specified, the fault verification apparatus 1 distributes the delay fault to the respective paths, which will be described later.

(3) Verification Method

The logic simulation and comparison with an expected value are repeated based on the following procedure:

(a) Perform a logic simulation of a normal circuit and make the simulation result an expected value;

(b) Change the delay only for one limited fault point;

(c) Perform the logic simulation;

(d) Compare the simulation result at a specific time with the expected value; and

(e) Repeat the steps (a) to (d) every time the delay is changed.

When a check of the one fault point is made by changing the delay by a specified width and is completed on a delay value within a predetermined range, a check of the next fault point is repeatedly made in the same manner.

(4) Judgment of Detection

As a result of comparison with the expected value, if the simulation result is different from the expected value at a specified comparison point, it is verified that the delay fault can be detected, and if the simulation result is equal to the expected value at all the specified comparison points, it is verified that the delay fault cannot be detected. For example, a delay fault is generated in each pin of the flip-flop shown in FIG. 2 and the output result of simulation is compared with the output result of the normal circuit. In a case where a time when the output result is compared with the expected value is limited to the time S1, the delay faults caused at almost all the pins cannot be detected. By adding a comparison with the expected value at the time S2, all the delay faults can be detected. In such a way, the quality of the test pattern can be improved.

Hereinafter, a method of generating a delay fault and an operation of verifying a delay fault as the greatest features of the present invention will be described. However, as shown in FIG. 2, the delay abnormality includes the two cases of delay increase and delay decrease. Therefore, the respective cases of the delay abnormality will be described separately.

1. The Case of Delay Increase

A fault due to delay increase is the one in which an LSI does not operate normally because a signal is delayed in propagation as compared with a normal delay circuit. Hereinafter, the evaluation of reliability of a test pattern corresponding to a delay fault due to delay increase will be described.

A fault-generated point is generated at the input port and the output port of a logic gate (in which an output signal is varied depending on the state of an input signal), or a net (wiring for connecting gates). On verifying a delay fault, a fault generated at the fault point is generated in a pseudo manner by advancing or delaying the timing of a signal passing the fault point, which is different from the prior art.

The results of logic simulation to a normal circuit having a normal delay are compared with those of logic simulation to a fault circuit to which a delay fault is inserted and if the results are different between the normal circuit and the fault circuit at a specified comparison time, it is judged that the fault can be detected and if the results are equal to each other at all the specified comparison times, it is judged that the fault cannot be detected.

An embodiment in a case where the delay increases (in a case where a signal which passes a fault point delays in propagation as compared with a normal delay) will be described in the following.

(1) Fault-Generated Point

A fault-generated point is generated at the input port and the output port of a logic gate and a net for connecting the logic gates, and a delay fault is inserted therein.

(2) Range of an Abnormal Delay to be Verified

A user of the present apparatus defines the range of an abnormal delay that the user wants to verify. Further, the user of the present apparatus defines the amount of change by himself in a case where the user wants divide the range of the abnormal delay to be verified (in a case where delays of +1 ns, +2 ns, +3 ns, +4 ns, +5 ns are verified within the range of +5 ns, the amount of change is 1 ns).

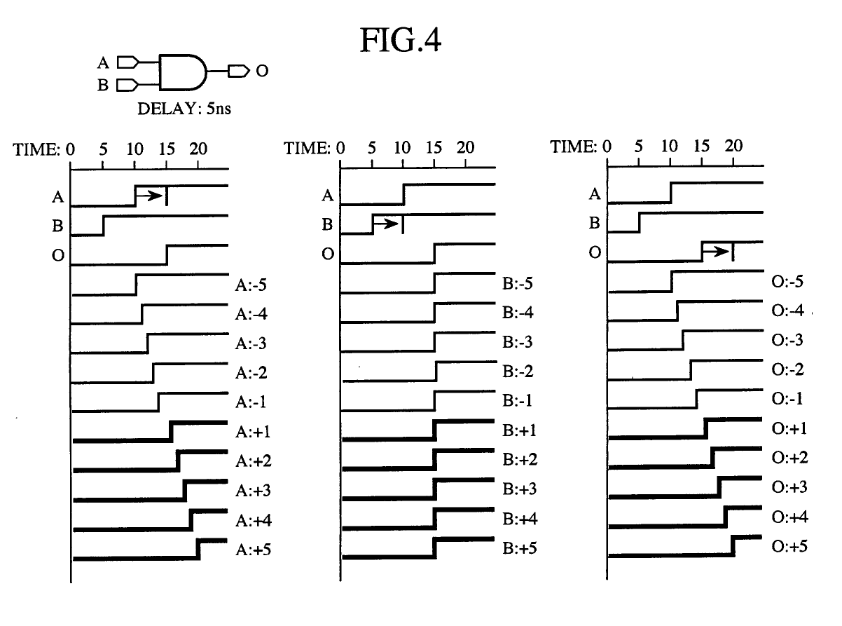

FIG. 4 shows modified examples of the delay to be verified and shows timing charts in a case where a delay is applied to each port of an AND gate (decrease: range that the user wants to check; increase: range that the user wants to check; step: range of the lowest common multiple of a delay value to be specified from simulation accuracy). In this example, inacase where a fault up to +5 ns is to be verified at one fault point by changing the delay by a unit of 1 ns, the amount of delay to be verified and the amount of delay per one operation are defined as 5 ns and 1 ns, respectively, and when the delay at the fault point increases as compared with the normal delay (when a signal which passes the fault point delays as compared with the normal delay), the delay faults in the cases of +1 ns, +2 ns, +3 ns, +4 ns, and +5 ns are verified. Similarly, when the delay at the fault point decreases (a signal which passes the fault point advances as compared with the normal delay), the delay faults in the cases of −1 ns, −2 ns, −3 ns, −4 ns, and −5 ns are verified respectively.

Since the embodiment 1 is an example of a delay fault caused by a delay increase, the delay faults in the cases of +1 ns, +2 ns, +3 ns, +4 ns, and +5 ns of normal delay are verified.

(3) Fault Generation Method

When checking a delay abnormality in which the width of abnormal delay to be verified is 5 ns and a delay increases 1 ns by 1 ns, a delay fault is caused at the output port and the input port of the logic gate and net. A fault generation method will be described separately for each of states of connection at the fault-generated point.

(a) A Case Where a Delay Fault is Generated at the Output Port of a Logic Gate

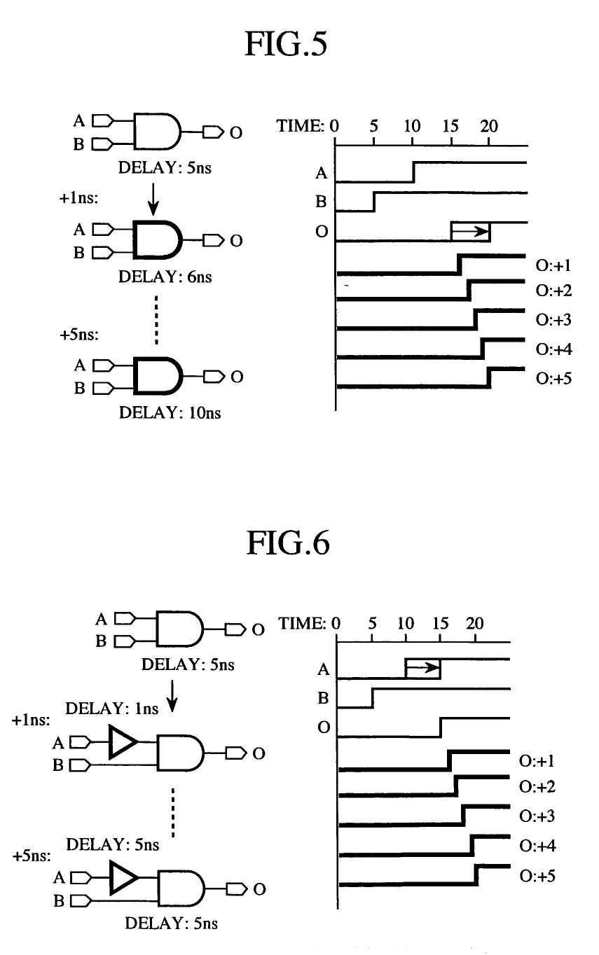

A delay is added to the self-delay of a logic gate of a targeted output port (self-delay means the difference between a time when a signal which passes the logic gate is inputted to the logic gate and a time when the signal is outputted from the logic gate). FIG. 5 shows a fault generation example in which the delay of an output port O increases. For example, in a case where the self-delay of an AND gate is 2 ns, when a delay fault of +1 ns is generated, the self-delay is changed to 3 ns. Similarly, in a case where the delay fault of +2 ns is generated, the self-delay is changed to 4 ns to cause the delay fault. In this manner, when the checking of the delay faults up to +5 ns (the self-delay of 7 ns) is completed, the delay faults are generated for the other fault points and are verified. Incidentally, hereinafter, the delay is increased or decreased in the logic gate shown by a thick line in the drawings.

(b) A Case Where a Delay Fault is Generated to the Input Port of a Logic Gate

A buffer gate (in which an input signal is outputted just as it stands) for adding delay is inserted into a wiring connected to a targeted input port to change the wiring as shown in FIG. 6. FIG. 6 shows a fault generation example in which the delay of an input port A increases. The self-delay of the inserted buffer gate (shown by a thick line) for adding delay is basically +5 ns and when a delay fault of +1 ns is generated, the self-delay is changed to +6 ns. Similarly, in a case where a delay fault of +2 ns is generated, the self-delay is changed to 2 ns to generate the delay fault. In such a way, when the checking of the delay faults up to +5 ns is completed, the delay faults are generated for the other fault points and are verified.

(c) A Case Where a Delay Fault is Generated for a Net (Wiring for Connecting Gates)

In a case where a delay fault is caused for a net, it is necessary to classify the states of connection of gates to be connected and to generated the delay faults which meets the respective states. Techniques of generating a fault, taking into account the respective states of connection, will be described in the following.

(c-1) A Case Where a Signal Path is not Branched

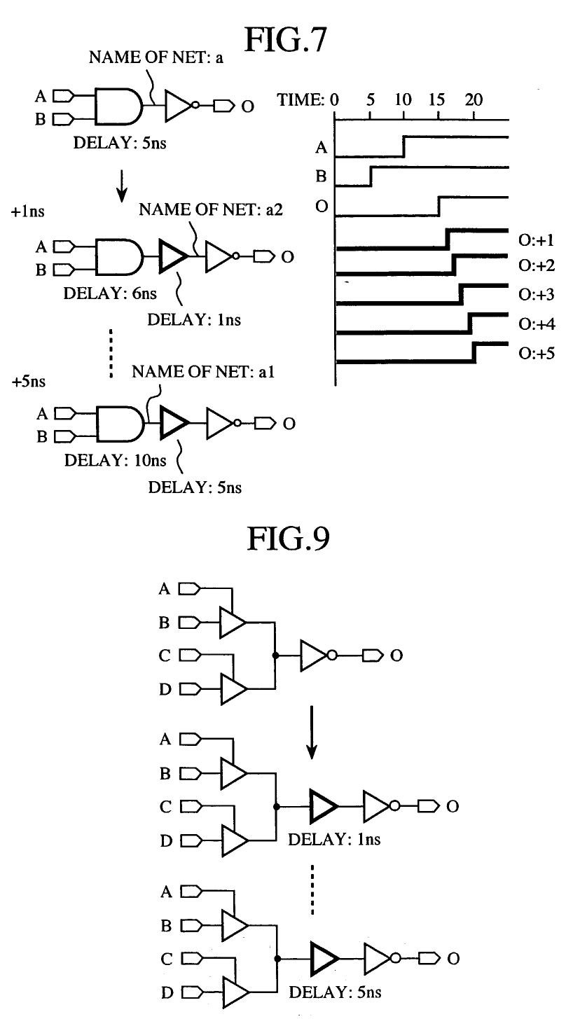

In a case where a plurality of output ports and a plurality of input ports are not connected to a net but one output port and one input port are connected to a net, FIG. 7 shows a fault generation example in which the delay of the net increases and in which a buffer gate (shown by a thick line) for adding delay is inserted into the net to change the connection. The self-delay of the inserted buffer gate for adding delay is basically 0 ns and in a case where the delay fault of +1 ns is generated, the self-delay of the inserted buffer gate for adding delay is changed to 1 ns. Similarly, in a case where the delay fault of +2 ns is generated, the self-delay of the inserted buffer gate for adding delay is changed to 2 ns. When the verification of the delay faults up to +5 ns (the self-delay of 5 ns) is completed in this manner, delay faults are generated for the other fault points and are checked.

(c-2) A Case Where a Signal Path is Branched

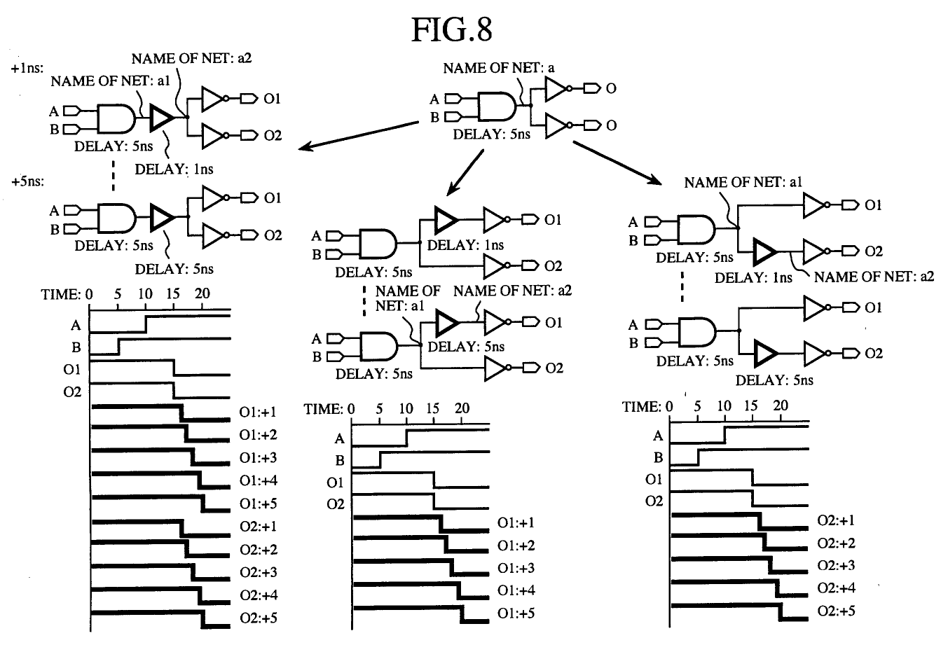

FIG. 8 shows a fault generation example (a plurality of inputs) in which a net delay increases. In a case where a plurality of input ports are connected to a net in this manner, a buffer gate (shown by a thick line) for adding delay is inserted into each input port to change connection. The self-delay of the inserted buffer gate for adding delay is basically 0 ns and when a delay fault of +1 ns is generated, the self-delay of the self-delay buffer gate is changed to 1 ns. Similarly, when a delay fault of +2 ns is generated, the self-delay of the self-delay buffer gate is changed to 2 ns to generate the delay fault. In such a way, when the verification of the delay faults up to +5 ns (self-delay of 5 ns) is completed, the delay faults are generated for the other fault points and are checked.

(c-3) A Case Where a Plurality of Signal Paths are Converged

FIG. 9 shows a fault generation example (a plurality of outputs) in which the net delay increases. In a case where a plurality of input ports are connected to a net, a buffer gate (shown by a thick line) for adding delay is inserted into each input port in this manner to change connection. The self-delay of the inserted buffer gate for adding delay is basically 0 ns and when a delay fault of +1 ns is generated, the self-delays of all the self-delay buffer gates are changed to 1 ns. When the verification of the delay faults up to +5 ns (self-delay of 5 ns) is completed in this manner, the delay faults are generated for the other fault points and are checked.

(4) Verification Method

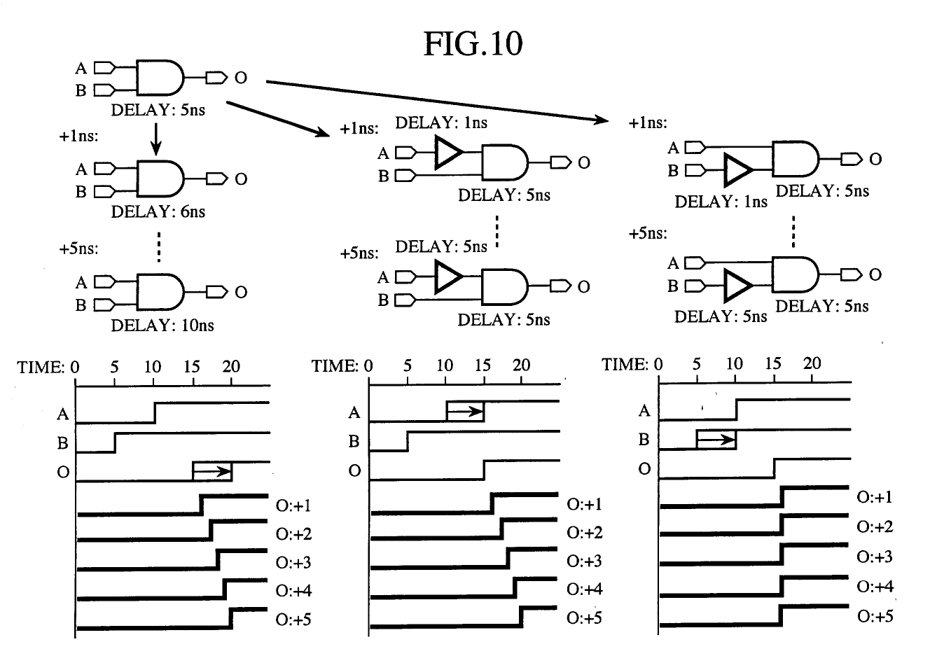

FIG. 10 shows a verification example of a delay fault in which a delay increases. As shown in FIG. 10, taking a case where the self-delay of a two-input AND gate is 5 ns as an example, a method of verifying a delay fault in which a delay increases will be described. First, a logic simulation is performed for a normal circuit (circuit having a normal delay) and the results of the logic simulation are stored as an expected value. Next, a delay fault is inserted into the two-input AND gage to produce a fault circuit. It is acceptable that the verification of the fault starts from any port, so in the example shown in FIG. 10, to begin with, the delay fault of output port O is verified. In a case where a delay fault is generated due to a delay increase of the output port O, a delay is added to the self-delay of the two-input AND gate. In a case where a delay fault of +1 ns is verified, the self-delay of the two-input AND gate is changed to 6 ns (see left-drawing in FIG. 10) to make a fault circuit in which a delay fault is generated. A logic simulation of the fault circuit is performed and the results of the logic simulation are compared with the expected values (which are results of logic simulation of the fault circuit) at a specific time. Then, if they are different from each other at a specific time, it is judged that the fault can be detected and if they are equal to each other at all the specific times, it is judged that the fault cannot be detected.

Similarly, in a case where a delay fault of +2 ns is verified, the self-delay of the two-input AND gate is changed to 7 ns to make a fault circuit in which a delay fault is generated. The logic simulation of the fault circuit is performed and the results of the logic simulation are compared with the expected value of the normal circuit at a specific time. Then, if they are different from each other at the specific time, it is judged that the fault can be detected, and if they are equal to each other at all the specific times, it is judged that the fault cannot be detected. When the verification of the delay faults up to +5 ns (self-delay of 10 ns) is completed, the delay faults are generated for the other fault points and are verified. In this example, the input port A or B of the two-input AND gate will be verified. When the input port A is verified, a buffer gate (shown by a thick line) for adding delay is inserted into a wiring connected to the input port A to change the wiring as shown in FIG. 10. The self-delay of the inserted buffer gate for adding delay is basically made 0 ns. In a case where a delay fault of +1 ns is generated, the self-delay of the buffer gate for adding delay is changed to 1 ns. As is the case with the output port, the logic simulation is performed and the logic simulation results are compared with the expected value.

The logic simulation results are compared with the expected value at a specific time. Then, if the logic simulation results are different from the expected value at the specific time, it is judged that the fault can be detected, and if the logic simulation results are equal to the expected value at all the specific times, it is judged that the fault cannot be detected. Similarly, in a case where a delay fault of +2 ns is generated, the self-delay is changed to 2 ns to generate the delay fault. In this manner, when the verification of the delay faults up to +5 ns (the self-delay of the buffer gate for adding delay becomes 5 ns) is completed, the remaining port B is verified and completed. In a case where there exists the other logic gate or case where the net is also verified, a delay fault which satisfies the fault generation condition of each fault point is generated and verified.

2. A Case of Delay Decreases (However, a Case Where a Gate Delay is not Smaller Than 0 ns)

The evaluation of reliability of a test pattern adaptable to a delay fault due to delay decrease will be described below.

In fault verifications, by logically operating each gate in an LSI circuit by use of the test pattern that is input data, the reliability of the test pattern is verified. Specifically, the results of the logic simulation in a case where the circuit is in a normal state are compared with those of the logic simulation of a fault circuit into which a delay fault is inserted at one point. If the results are different from each other between the circuits at a specific time, it is judged that the fault can be detected and if the results are equal to each other at all the specific times, it is judged that the fault cannot be detected. Similarly, a fault is generated at another point of the circuit and it is judged whether the fault can be detected or not.

The fault point is caused at the input port and the output port of the logic gate (in which an output signal varies according to the state of an input signal) or a net (wiring for connecting the gates). The fault inserted into the fault point is caused in a pseudo manner by advancing or delaying the timing of a signal which passes the fault point, which is different from a fault verification apparatus in the related art.

Then, the results of a logic simulation for a normal circuit having a normal delay are compared with those of a logic simulation of a fault circuit into which a delay fault is inserted. If the results are different from each other between the normal circuit and the fault circuit at a specific time, it is judged that the fault can be detected and if the results are equal to each other at all the specific times, it is judged that the fault cannot be detected.

An embodiment in a case where the delay decreases (in a case where a signal which passes the fault point advances as compared with a normal delay) will be described below.

(1) Fault-Generated Point

A fault is generated at the input port and the output port of the logic gate and a net for connecting the logic gates, and a delay fault is inserted therein.

(2) Amount of Decreased Delay to be Verified

The amount of decreased delay is set by advancing or delaying the time when a signal passes a fault point with respect to the time when a normal delay passes the fault point. A user of the present apparatus defines, by himself, the amount of the delay (range of time) that the user wants to verify. Further, the user of the present apparatus defines, by himself, also the amount of change in a case where the user wants divide the range of the delay to be verified.

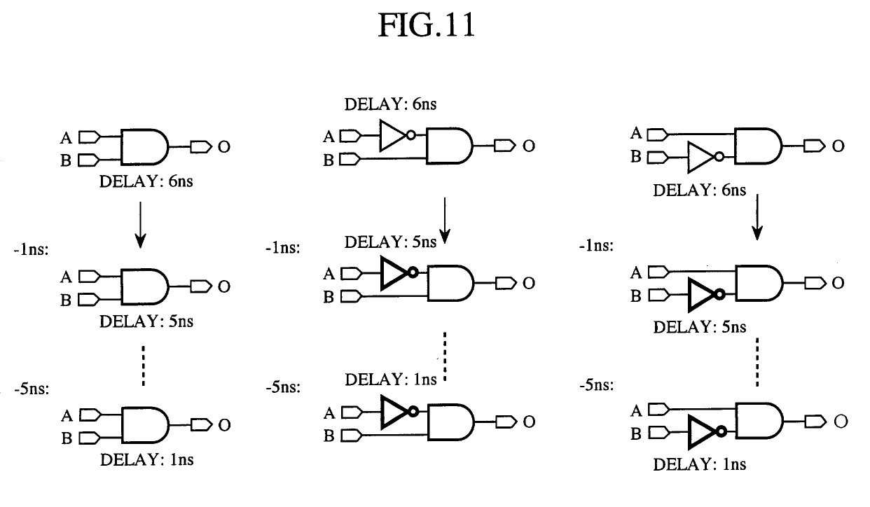

FIG. 11 shows delay fault generation examples in which a delay decreases. In a case where faults up to 5 ns are to be checked at one fault point by changing (decreasing) the delay by a unit of 1 ns, that is, in a case where the amount of delay to be verified is defined 5 ns and the amount of delay to be changed for one operation is defined 1 ns, delay faults are checked in which delay at the fault point decreases by −1 ns, −2 ns, −3 ns, −4 ns, and −5 ns with respect to the normal delay (a signal which passes the fault point advances in propagation as compared with the normal delay). While the embodiment 1 described above is a case of the delay fault due to delay increase; in this embodiment, the delay faults are verified in cases where delay decreases by −1 ns, −2 ns, −3 ns, −4 ns, and −5 ns to the normal delay.

(3) Fault Generation Method

In a case where a delay abnormality is checked in which the width of the abnormal delay to be verified is 5 ns and the abnormal delay decreases 1 ns by 1 ns, a delay fault is generated at the output port and the input port of the logic gate and a net. It will be described separately for each condition.

(a) A Case Where a Delay Fault is Generated at the Output Port of a Logic Gate

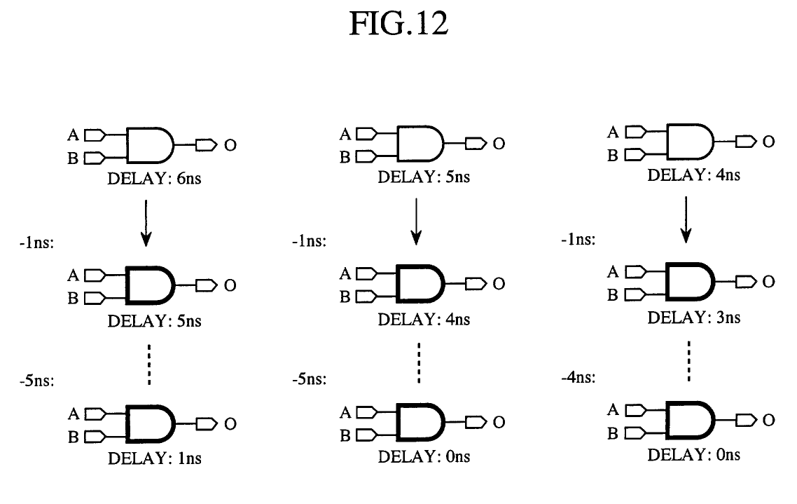

The self-delay involved by the logic gate of a targeted output port (i.e., a difference between a time when a signal which passes the logic gate is inputted to the logic gate and a time when the signal is outputted from the logic gate) is decreased. FIG. 12 shows a fault generation example in which an output delay decreases (an example in which the self-delay is not smaller than 0 ns). For example, in a case where the self-delay of a two-input AND gate is 5 ns, as shown in FIG. 12, in a case where a delay fault of −1 ns is generated, the self-delay is changed to 4 ns. Similarly, in a case where a delay fault of −2 ns is generated, the self-delay is changed to 3 ns to generate the delay fault. When the verification of the delay faults up to −5 ns (self-delay of 0 ns) is completed in this manner, the delay faults are generated for the other fault points and verified.

(b) A Case Where a Delay Fault is Generated to the Input Port of a Logic Gate

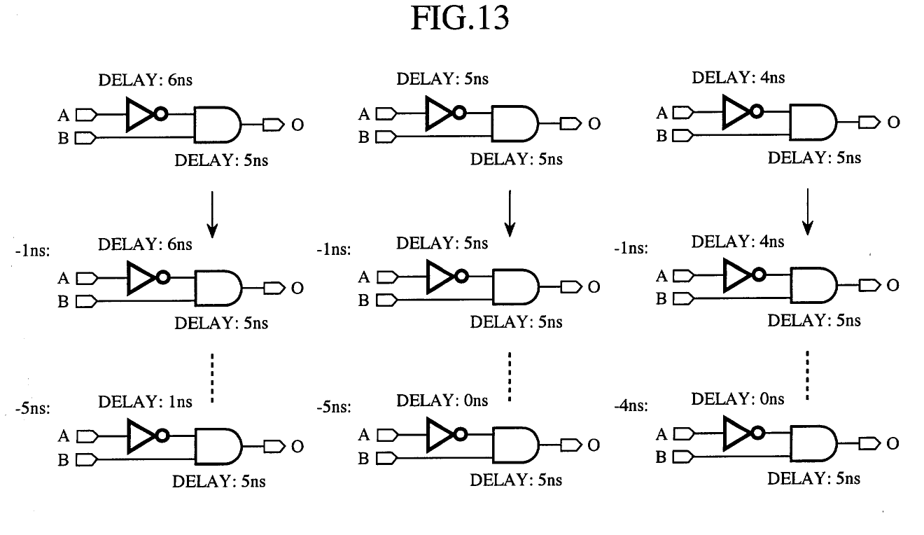

FIG. 13 shows an example of causing a delay fault in which an input delay decreases (an example in which a self-delay is not smaller than 0 ns). In this manner, an input port A of a two-input AND gate will be described as an example. An inverter gate (shown by a thick line in FIG. 13) is connected to the input port A. In order to generate the delay fault of the input port in which a delay decreases, a signal which passes the fault point is required to be advanced in propagation as compared with the normal circuit, so that the self-delay of the upstream inverter gate connected to the input port A is decreased. In the case shown in FIG. 13, since the self-delay connected to the input port A, in a case where a delay of −1 ns is generated, the self-delay of the inverter gate is changed to 4 ns. Similarly, in a case where a delay of −2 ns is generated, the self-delay of the inverter gate is changed to 3 ns to generate the delay fault. When the verification of the delay faults up to −5 ns (self-delay of 0 ns) is completed in this manner, the delay faults are generated for the other fault points and verified.

(c) A Case Where a Delay Fault is Generated for a Net (Wiring for Connecting Gates)

(c-1) In a Case Where a Signal Path is not Branched

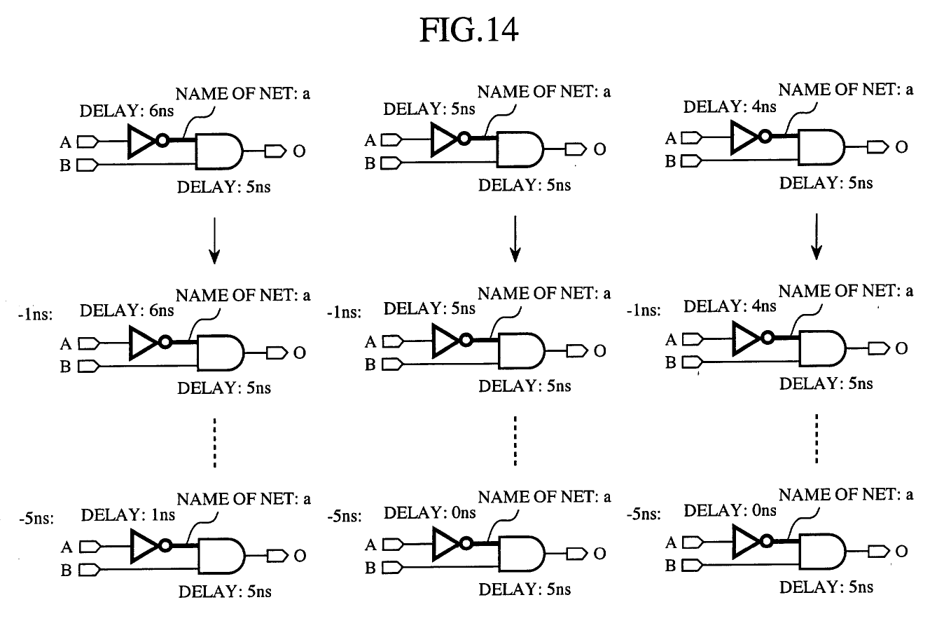

FIG. 14 shows a delay fault generation example in which the delay of a net which is not branched decreases (a case where a self-delay is not smaller than 0 ns). Thus, in a case where a plurality of output ports and a plurality of input ports are not connected to a net, but one output port and one input port are connected to a net, one inverter gate (shown by a thick line) is connected to a net “a” connected to the input port A of a two-input AND gate. In order to generate the delay fault of the net in which the delay decreases, a signal which passes the fault point is required to be advanced in propagation as compared with the normal circuit, so that the self-delay of the upstream inverter gate connected to the net “a” is decreased. In the case of FIG. 14, since the self-delay of the inverter gate connected to the input port A is 5 ns, in order to generate a delay fault of −1 ns, the self-delay of the inverter gate is changed to 4 ns. Similarly, in a case where a delay fault of −2 ns is generated, the self-delay is changed to 3 ns to generate a delay fault. When the verification of the delay faults up to −5 ns (self-delay of 0 ns) is completed in this manner, delay faults are generated for the other fault points and are verified.

(c-2) A Case Where a Signal Path is Branched

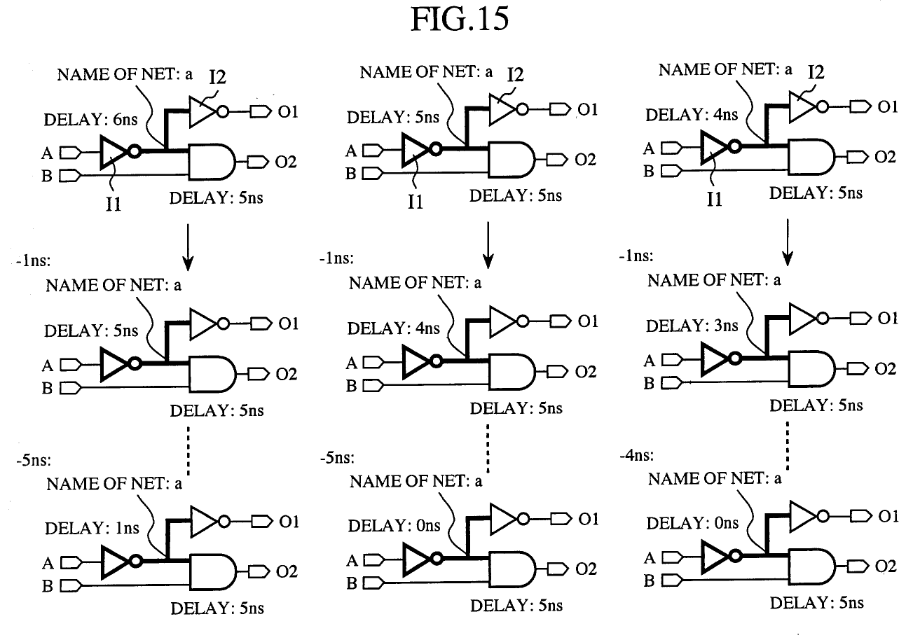

A case where a plurality of input ports are connected to one net will be described. FIG. 15 shows an example of a delay fault in which the delay of the branched net decreases (the case where self-delay is not smaller than 0 ns). Thus, two inverter gates (shown by thick line) are connected to a net “a” connected to the input port A of a two-input AND gate (where each logic gate is denoted by a name of I “number” in order to identify the inverter gate). A gate I1 is connected to the net “a” in such a way as to output a signal therefrom and a gate I2 is connected to the net “a” in such a way as to input a signal thereto. In order to generate the delay fault of the net in which the delay decreases, a signal which passes the fault point is required to be advanced in propagation as compared with the normal circuit, so that the self-delay of the upstream inverter gate I1 connected to the net “a” in such a way as to output a signal is decreased.

Incidentally, in the case of FIG. 15, since the self-delay of the inverter gate I1 outputting a signal to the net “a” is 5 ns, in a case where a delay fault of −1 ns is caused, the self-delay of the inverter gate I1 is changed to 4 ns. Similarly, in a case where a delay fault of −2 ns is generated, the self-delay is changed to 3 ns to generate the delay fault. When the checking of the delay faults to −5 ns (self-delay of 0 ns) is completed in this manner, delay faults are generated for the other fault points and are verified.

(c-3) A Case Where a Plurality of Signal Paths are Converged

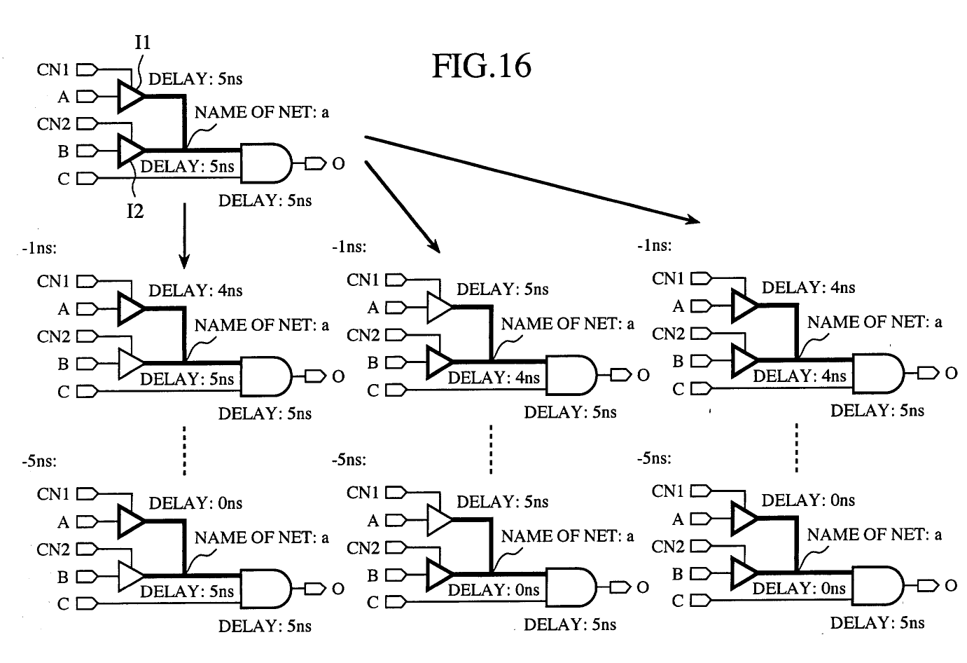

A case where a plurality of output ports are connected to one net will be described. FIG. 16 shows an example of a delay fault in which the net delay to be converged decreases (a case where the self-delay is not smaller than 0 ns). In this manner, two control buffer gates (in which a signal inputted to input port A is outputted to output port O when the state of control input port C is 1 and in which nothing is outputted when the state of control input port C is 0) are connected to a net “a” connected to the input port A of the two-input AND gate (in order to identify the control buffer gate, each logic gate is denoted by a name of I “number”). The control buffer gates I1, I2 are connected to the net “a” in such a way as to output a signal.

In order to generate the delay fault of the net in which the delay decreases, a signal which passes the fault point is required to be advanced in propagation as compared with the normal circuit, so that both the self-delays of the control buffer gates I1, I2 located at the front stage and connected the net “a” in such a way as to output a signal are decreased. In the case of FIG. 16, since each self-delay of the control buffer gates I1, I2 outputting a signal to the net “a” is 5 ns, in a case where a delay fault of −1 ns is generated, both the self-delays of the control buffer gates I1, I2 are changed to 4 ns. Similarly, in a case where a delay fault of −2 ns is generated, each self-delay is changed to 3 ns to generate the delay fault. When the verification of the delay faults to −5 ns (the self-delay of 0 ns) is completed in this manner, delay faults are generated for the other fault points and are verified.

3. A Case Where Delay Decreases (However, a Case Where a Gate Delay is Smaller Than 0 ns)

The evaluation of reliability of a test pattern corresponding to a delay fault in which delay decreases will be described in the following.

In this example, by decreasing delay, as is the case with the example 2 described above, a signal which passes the delay fault point is advanced in propagation as compared with the normal circuit. An example in which a delay fault in a range exceeding the self-delay of a logic gate for decreasing the delay is verified, as is the case with the example 2, will be described.

(1) Fault-Generated Point

A description will be omitted because this is the same as the example 2 described above.

(2) Amount of Delay to be Verified

A description will be omitted because this is the same as the example 2 described above.

(3) Fault Generation Method

There will be described a fault generation method in a case where a delay abnormality is verified in which the width of the abnormal delay to be checked is 5 ns and the abnormal delay decreases 1 ns by 1 ns. The description will be given for each condition, such that a delay fault is generated at each of the output and input ports of a logic gate, and a net. Further, there will be described a case where the width of the decreased delay exceeds the self-delay of the logic gate.

(a) A Case Where a Delay Fault is Generated at the Output Port of a Logic Gate

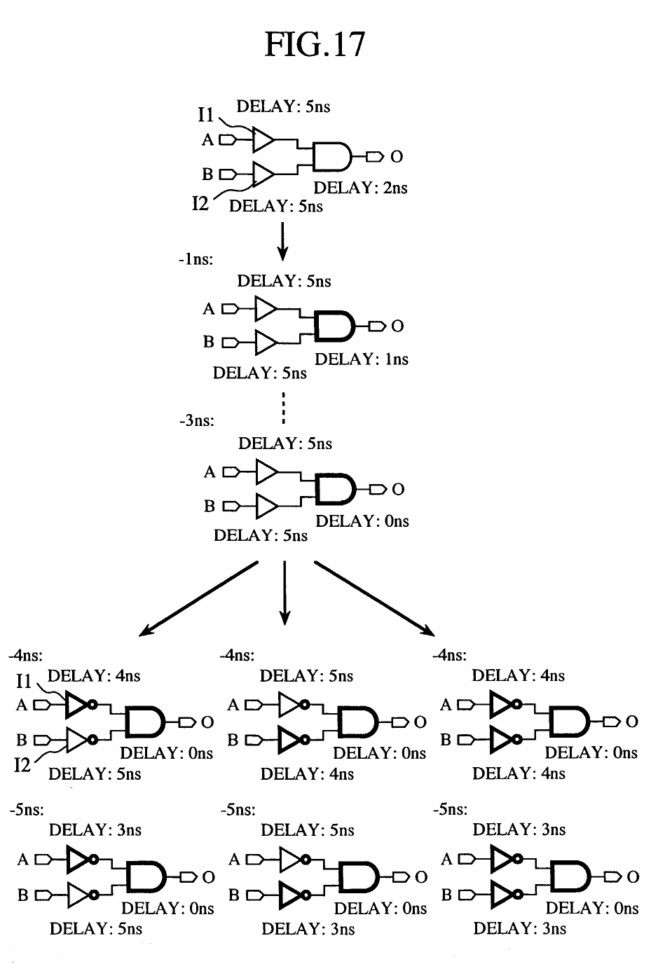

The self-delay involved by the logic gate of a targeted output port (that is, a difference between a time when a signal passing the logic gate is inputted to the logic gate and a time when the signal is outputted from the logic gate) is decreased. FIG. 17 shows an example of causing a delay fault in which the delay decreases (the case where the self-delay is smaller than 0 ns). In a case where the self-delay of a two-input AND gate is 2 ns and where both the self-delays of the inverter gates located at the front stage and connected to the two-input AND gate are 3 ns, as shown in FIG. 17, in order to generate a delay fault of −1 ns, the self-delay of the two-input AND gate is changed to 1 ns. Similarly, in order to generate a delay fault of −1 ns, the self-delay of the two-input AND gate is changed to 0 ns to generate the delay fault. In order to generate a delay of −3 ns, the self-delay of the two-input AND gate is changed to 0 ns and the remaining −1 ns is produced by decreasing the upstream logic gate for inputting a signal to the two-input AND gate, that is, as shown in FIG. 17, by decreasing the upstream logic gate connected to the input port A or B of the two-input AND gate.

A method of generating a delay fault of −3 ns includes the following three cases: two cases where the amount of delay that cannot be produced by decreasing the self-delay is produced by decreasing the self-delay of the logic gate connected to the input port A or the input port B of the two-input AND gate; and a case where the amount of delay that cannot be produced by decreasing the self-delay is produced by decreasing the self-delays of both the logic gates connected to the input port A and the input port B of the two-input AND gate.

(a-1) A Case Where the Path of an Input Port A is Verified

Since one inverter gate I1 is connected to the input port A, the self-delay of the two-input AND gate is made 0 ns and the self-delay of the inverter gate I1 is made 1 ns to generate a delay fault.

(a-2) A Case Where the Path of an Input Port B is Verified

In order to verify the path of the input port B in the same way as the input port A, the self-delay of the two-input AND gate is made 0 ns and the self-delay of the inverter gate I2 is made 1 ns to generate a delay fault.

(a-3) A Case Where Both the Paths of Input Ports A and B are Verified

Further, in order to make the paths of the input ports A and B have a delay fault of −3 ns, the self-delay of the two-input AND gate is made 0 ns and each self-delay of the inverter gates I1 and I2 is made 1 ns to generate a delay fault.

In a case where the self-delay is smaller than 0 ns, as described above, the delay of the upstream logic gate connected to the logic gate whose self-delay is smaller than 0 ns is decreased to generate a delay fault. When the verification of the delay faults to −5 ns (self delay is 0 ns) is completed, delay faults are generated for the other fault points and are checked.

In a case where the delay of the upstream gate is decreased, the delay is decreased by combining the paths in which the signals propagate to generate delay faults that could occur.

(b) A Case Where a Delay Fault is Generated at the Input Port of a Logic Gate

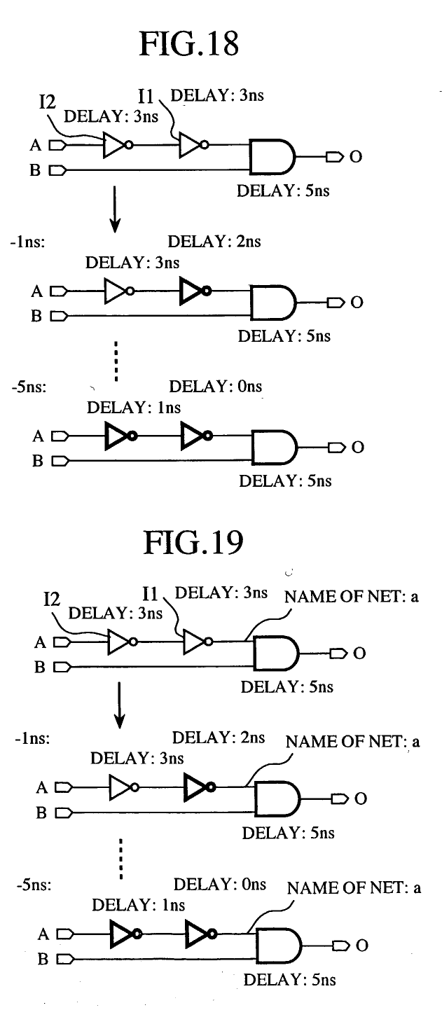

FIG. 18 shows a fault generation example of delay fault in which an input delay decreases (the case where the self-delay is smaller than 0 ns). The case of the input port A of a two-input AND gate will be described as an example. One inverter gate I1 is connected to the input port A. Further, an inverter gate I2 is connected to the upstream side of the inverter gate I1. In order to cause a delay fault of the input port in which the delay decreases, a signal which passes a fault point is required to be advanced in propagation as compared with the normal circuit, so that the self-delay of the upstream inverter gate I1 connected to the input port A is decreased. In the case of FIG. 18, the self-delay of the inverter gate I1 connected to the input port A is 3 ns, in order to cause a delay fault of −1 ns, the self-delay of the inverter gate I1 is changed to 2 ns. Similarly, in a case where a delay fault of −2 ns is generated, the self-delay of the inverter gate I1 is changed to 1 ns to generate a timing fault.

In a case where a delay fault of −4 ns is caused, the self-delay of the inverter gate I1 connected to the input port A of the two-input AND gate is made 0 ns and further the remaining −1 ns is produced by decreasing the self-delay of the upstream logic gate. As shown in FIG. 18, two inverter gates I1 and I2 are connected in series to the input port A of the two-input AND gate and further the self-delay of the upstream inverter gate I2 is made 2 ns to generate a delay fault of −4 ns.

In a case where the self-delay is smaller than 0 ns in this manner, the self-delay of the upstream logic gate connected to the logic gate whose self-delay is smaller than 0 ns is decreased to cause a delay fault. When the checking of the delay faults to −5 ns (self delay of 0 ns) is completed in this manner, the delay faults are generated for the other fault points and are verified.

In a case where the delay of the upstream gate is decreased, the delay is decreased by combining the paths in which the signals propagate to cause delay faults that could occur.

(c) A Case Where a Delay Fault is Caused for a Net (Wiring for Connecting Gates)

(c-1) A Case Where a Signal Path is not Branched

FIG. 19 shows a fault generation example of delay fault in which the net delay decreases (the case where self-delay is smaller than 0 ns). The following case will be described as an example: a plurality of output ports and a plurality of input ports are not connected to the net, but one output port and one input port are connected to the net at the input port A of the two-input AND gate. One inverter gate I1 is connected to the input port A. Further, an inverter gate I2 is connected to the upstream side of the inverter gate I1. In order to generate the delay fault of the input port in which the delay decreases, a signal which passes a fault point is required to be advanced in propagation as compared with the normal circuit, so that the self-delay of the upstream inverter gate I1 connected to the input port A is decreased. In the case of FIG. 19, the self-delay of the inverter gate I1 connected to the input port A is 3 ns. Thus, in order to generate a timing fault of −1 ns, the self-delay of the inverter gate I1 is changed to 2 ns. Similarly, in the case where a timing delay of −2 ns is generated, the self-delay of the inverter gate I1 is changed to 1 ns to generate a delay fault.

In order to generate a delay fault of −4 ns, the self-delay of the inverter gate I1 connected to the input port A of the two-input AND gate is made 0 ns and further the remaining delay of −1 ns is produced by decreasing the self-delay of the upstream logic gate. As shown in FIG. 19, two inverter gates I1 and I2 are connected in series to the input port A of the two-input AND gate and further the self-delay of the upstream inverter gate I2 is made 2 ns to generate a delay fault of −4 ns.

In a case where the self-delay is smaller than 0 ns in this manner, the delay of the upstream logic gate connected to the logic gate whose self-delay becomes smaller than 0 ns is decreased to generate a delay fault. When the verification of the delay faults to −5 ns (self-delay of 0 ns) is completed in this manner, delay faults are generated for the other fault points and are verified.

(c-2) A Case Where a Signal Path is Branched

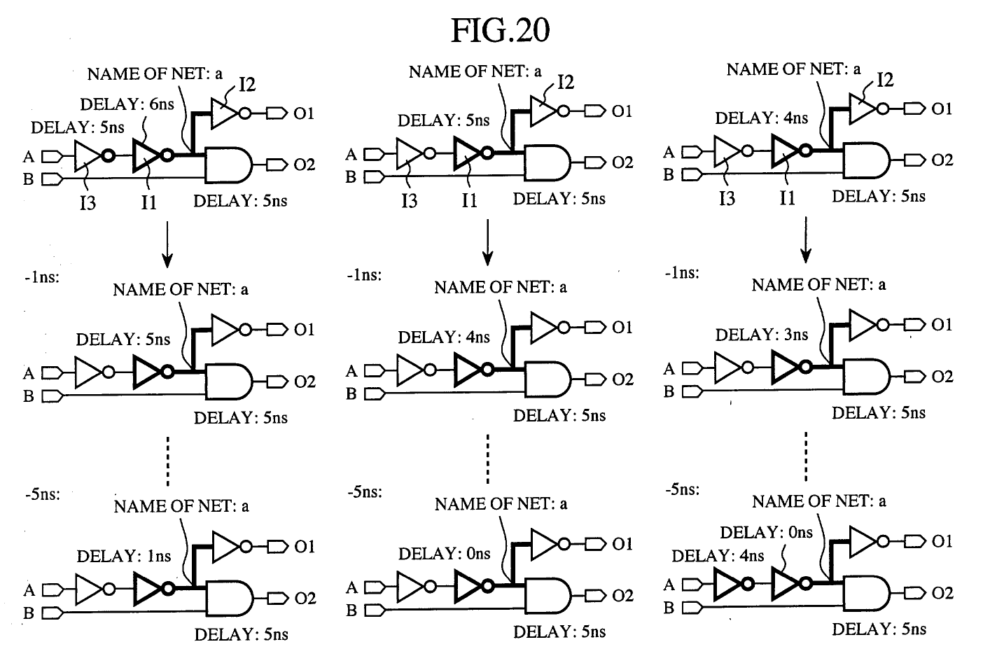

A case where a plurality of input ports are connected to one net will be described. FIG. 20 shows a fault generation example of delay fault of the net to which a plurality of input ports are connected (the case where the self-delay is not larger than 0 ns). In this manner, two inverter gates I1 and I2 are connected to a net “a” connected to the input port A of a two-input AND gate. The inverter gate I1 is connected to the net “a” in such a way as to output a signal to the net “a” and the inverter gate I2 is connected in such a way as to input a signal to the net “a”. Further, in the circuit in which an inverter gate I3 is connected to the upstream side of the inverter gate I1, in order to generate the delay fault in which delay of the net “a” decreases, a signal which passes a fault point is required to be advanced in propagation as compared with the normal circuit, so that the self-delay of the inverter gate I1 connected to the net “a” in such a way to output a signal to the net “a” is decreased.

In the case of FIG. 20, since the self-delay of the inverter gate I1 outputting a signal to the net “a” is 2 ns, in the case where a timing fault of −1 ns is generated, the self-delay of the inverter gate I1 is changed to 1 ns. Similarly, in the case where a timing fault of −2 ns is generated, the self-delay of the inverter gate I1 is changed to 0 ns to generate a delay fault. In the case where a delay fault of −3 ns is generated, the self-delay of the inverter gate I1 is made 0 ns and further the self-delay of the inverter I3 connected to the upstream side of the inverter I1 is decreased from 2 ns to 1 ns to generate a delay fault. When the verification of the delay faults to −5 ns (self-delay of ns) is completed in this manner, the delay faults are generated for the other fault points and are verified.

In this manner, in a case where the self-delay is not larger than 0 ns, the delay of the upstream logic gate connected to the logic gate of the self-delay not larger than 0 ns is reduced to generate a delay fault. When the verification of the delay faults to −5 ns is completed, delay faults are generated for the other fault points and are verified.

(c-3) A Case Where a Plurality of Signal Paths are Converged

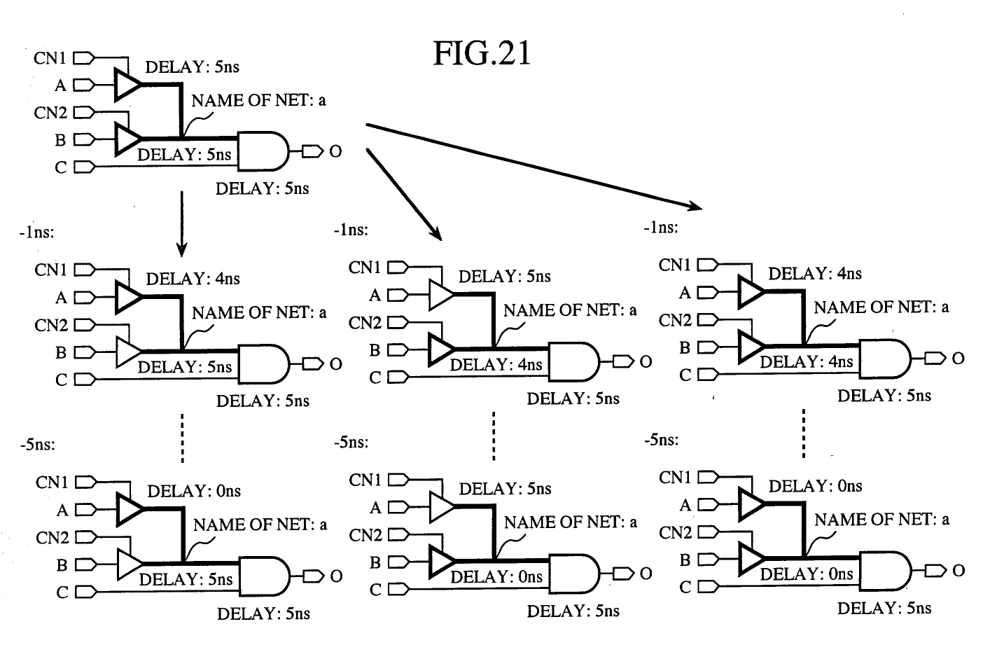

A case where a plurality of output ports are connected to one net will be described. FIG. 21 shows a fault generation example of delay fault of a net to which a plurality of output ports are connected (a case where the self-delay is not larger than 0 ns). In this manner, two control buffer gates I1 and I2 are connected a net “a” connected to the input port A of a two-input AND gate. Both the control buffer gates I1 and I2 are connected to the net “a” in such a way as to output a signal to the net “a”. In a case where a timing fault of the net in which delay decreases is generated, a signal which passes a fault point is required to be advanced in propagation as compared with the normal circuit, so that both the self-delays of the upstream control buffer gates I1 and I2 connected to the net “a” in such a way as to output a signal to the net “a” are decreased.

In the case of FIG. 21, the self-delays of the control buffer gates I1 and I2 outputting a signal to the net “a” are 2 ns, in the case where a delay fault of −1 ns is generated, both the self-delays of the control buffer gates I1 and I2 are changed to 1 ns. Similarly, in the case where a delay fault of −2 ns is caused, both the self-delays of the control buffer gates I1 and I2 are changed to 0 ns to generate a delay fault. In the case where a delay fault of −3 ns is generated, both the self-delays of the control buffer gates I1 and I2 are changed to 0 ns and further a remaining delay of −1 ns is produced by decreasing the self-delays of the logic gates connected to the upstream sides of the respective control buffer gates I1 and I2 to thereby cause a delay fault.

In this manner, in a case where the self-delay is not larger than 0 ns, the delay of the logic gate connected to the upstream side of the logic gate of the self-delay not larger than 0 ns is decreased to thereby generate a delay fault. When the verification of the delay faults up to −5 ns is completed, delay faults are generated for the other fault points and are verified.

(c-4) A Case Where a Plurality of Signals are Converged and Then Branched

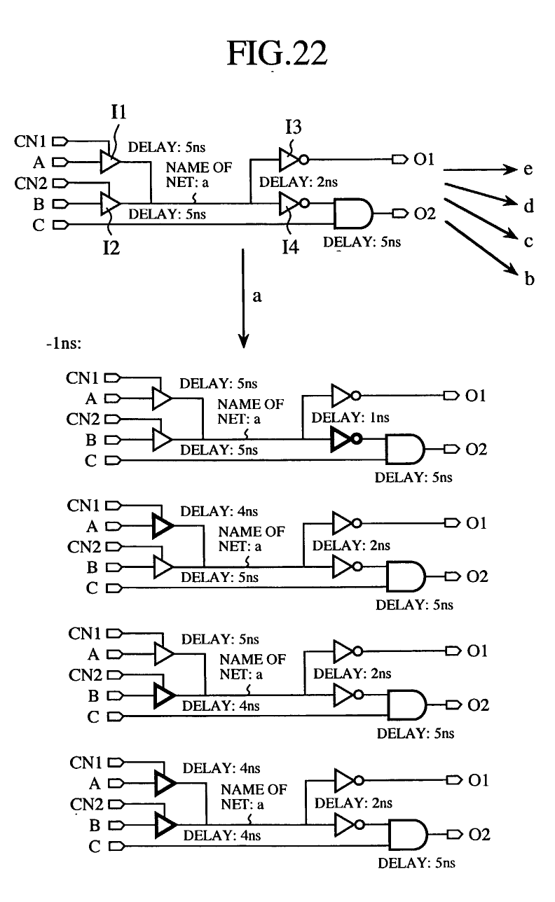

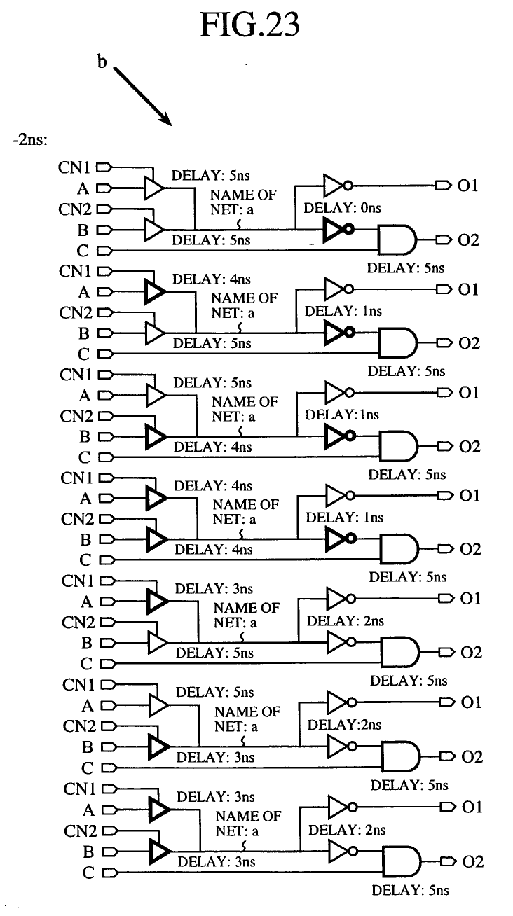

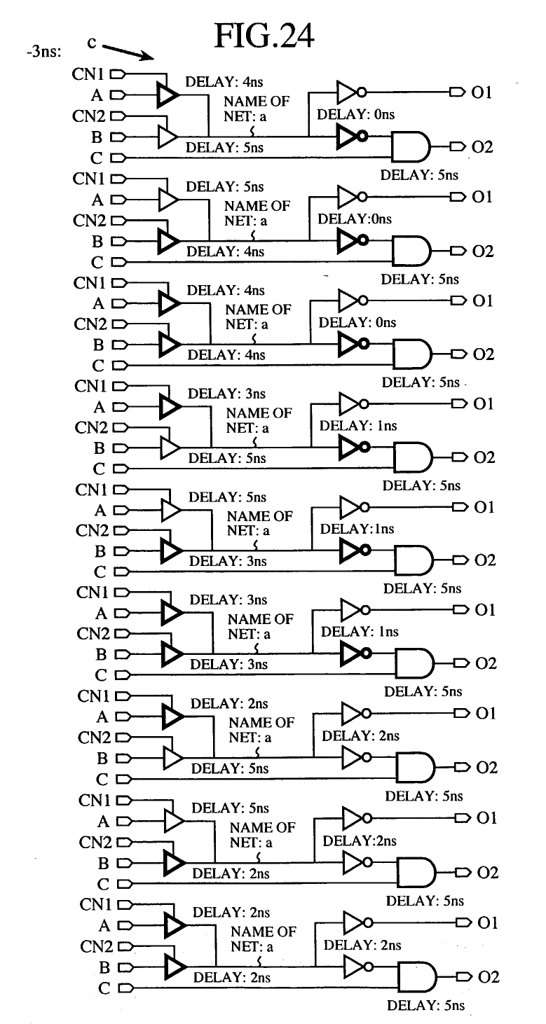

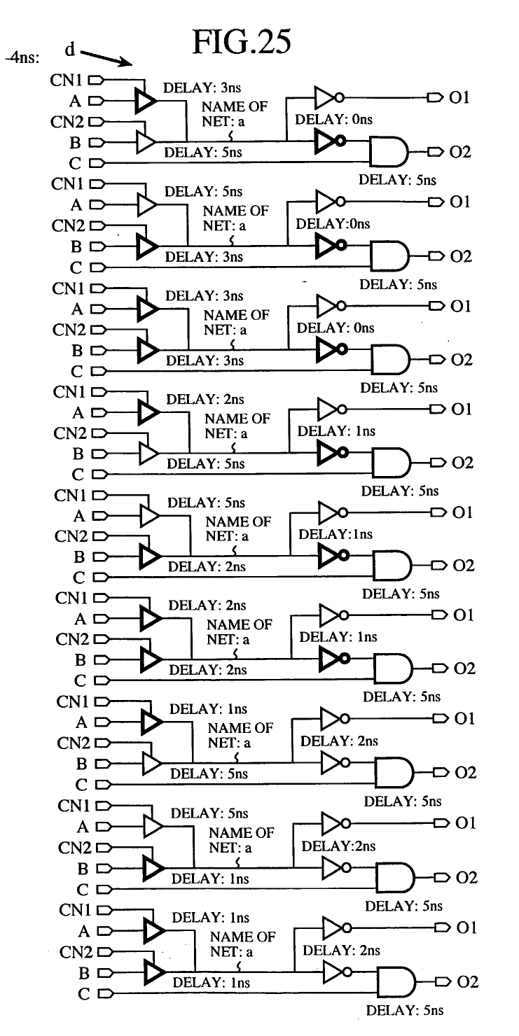

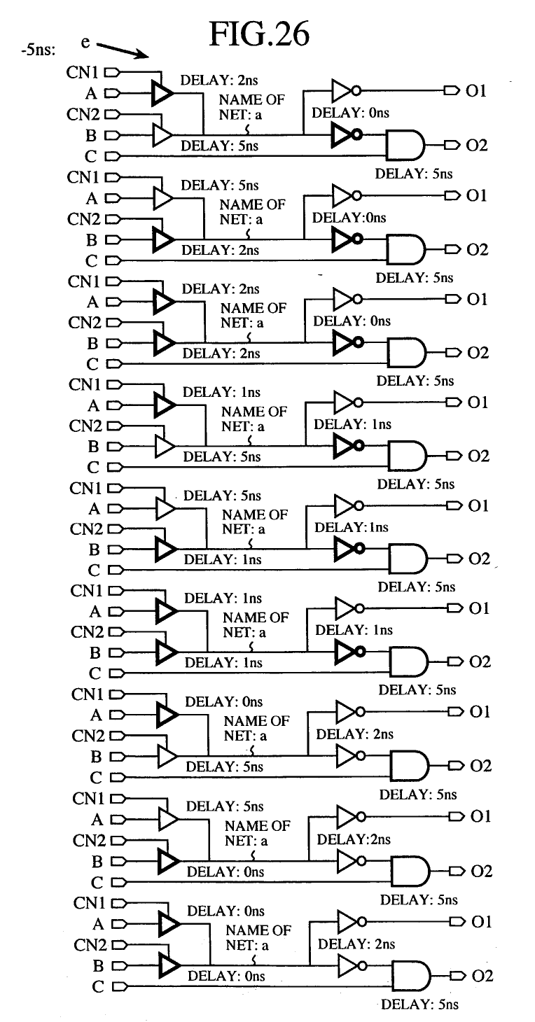

A case will be described in which a plurality of output ports and a plurality of input ports are connected to one net. FIGS. 22 to 26 show an example of causing a delay fault of a net to which a plurality of inputs and a plurality of outputs are connected (a case where the self delay is not larger than 0 ns). In this case, a net “a” is connected to an inverter 14 connected to the input port A of a two-input AND gate and in addition, two control buffer gates I1 and I2 and an inverter gate I3 are connected to the net “a”. The two control buffer gates I1 and I2 are connected to the net a in such a way as to output a signal to the net “a” and the inverter I3 is connected to the net “a” in such a way as to receive a signal from the net “a”. In order to generate the delay fault of a net in which delay decreases in a path connected to the two-input AND gate, a signal which passes the output port of the inverter gate I4 is required to be advanced in propagation as compared with the normal circuit, so that it is necessary to decrease the self-delay of the inverter gate I4 and decrease both the self-delays of the control buffer gates I1 and I2 connected to the net “a” in such a way as to output a signal to the net “a”.

As shown in FIGS. 22 to 26, a delay fault is generated by a combination of delay abnormalities to be caused before and after the net “a” which is a branch point of a signal propagating path and on the paths of the control buffer gates I1 and I2 that output a signal to the net “a”.

When the verification of the delay faults to −5 ns is completed, the delay faults are generated for the other fault points and are verified.

As described above, according to the embodiment 1, by performing the logic simulation of a circuit having a normal delay and the logic simulation of a circuit in which the delay is intentionally changed to a gate and a node and by comparing the results of the simulations at a specific time, it is possible to verify whether or not a test pattern can detect the faults caused by the delay abnormalities. Therefore, it is possible to improve the quality of the test pattern and reliability in checking the faults, which in turn leads to reduce the market loss of the semiconductor circuit resulting from the faults caused by delay abnormalities.

Embodiment 2

In a fault verification apparatus in the related art, in order to check a fault corresponding to “0”, “1” Stuck-At faults, it is necessary to insert a fault into the input and output ports of all the gates. However, the fault verification apparatus in accordance with the present invention handles a delay fault and hence is characterized in that the apparatus drastically reduces a checking time by recognizing a critical path or a clock line which is substantially affected by a timing fault and by making a check of only the limited critical path or the limited clock line.

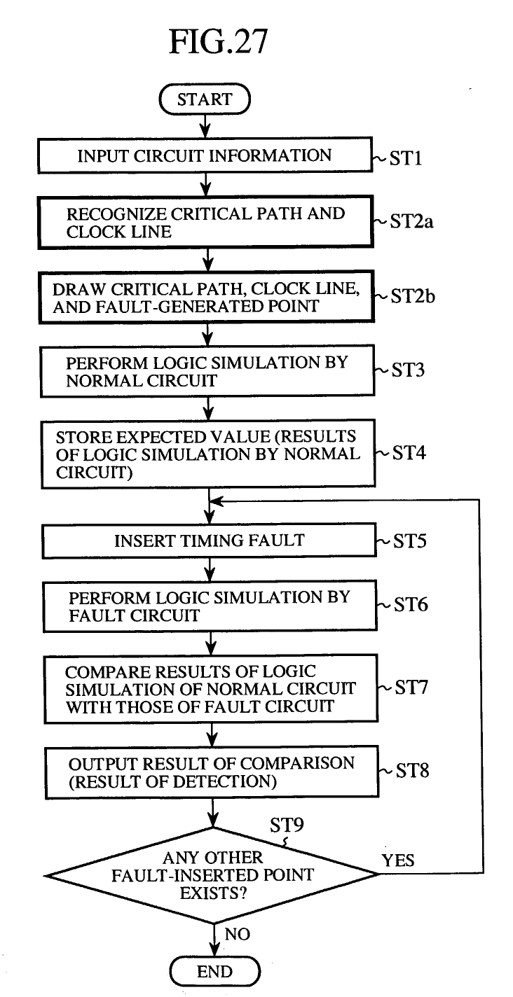

Describing an embodiment 2 in comparison with the fault checking flow of the above-mentioned embodiment 1, as shown in FIG. 27 that shows the fault checking flow of the embodiment 2 in accordance with the present invention, the fault causing section in FIG. 3, that is, a step of drawing a fault-generated point (step ST2) includes a step of recognizing a critical path and a clock line (step ST2a) and a step of drawing a fault-generated point in the critical path or the clock line (step ST2b).

The operation of a delay fault generating section and a delay fault verifying section point will be described in the following.

In the embodiment 2, the speed-up of a verification whether or not a fault due to a delay abnormality is detected will be described. The fault verification apparatus, that is, fault simulator performs a logic simulation of a normal circuit and a logic simulation of a failed circuit, and compares the results of the simulations at a specific time. The minimum number of performances of the simulation is given by the following equation (1)

Normal circuit×1+number of fault points to be caused =1+number of input/output ports of gate×width of delay to be checked/amount of change of delay (1)

Further, it is necessary to check all the combinations of delay reduction produced by branching paths and the like, which requires a lot of checking time. Therefore, it is necessary to eliminate unnecessary delay faults and to check only necessary delay faults and to eliminate overlapping faults in advance.

A method of eliminating unnecessary delay faults will be described in the following.

1. Critical Path

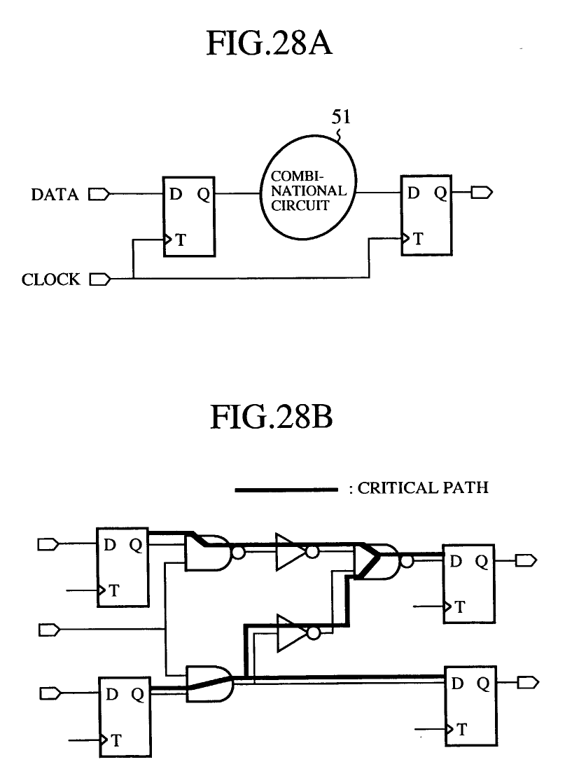

A critical path means a path in which a signal (data) propagates between a primary memory device (flip-flop and latch gate) and a secondary memory device (flip-flop and latch gate) and, as shown in FIG. 28 (in which a reference numeral 51 denotes a combinational circuit), the memory device (hereinafter referred to as “FF”) is controlled by a clock signal that is the base of operation of an LSI. When the signal propagates along the critical path to change a timing when the signal propagates to the data input terminal of the FF, the LSI is not operated normally. Therefore, a delay fault is caused for the data input terminal of the FF to which the signal propagating along such a critical path is inputted.

A method of recognizing the FF and the critical path is inputted by the techniques described below. Further, the method of recognizing may be inputted by any one of the techniques, so it is not specified.

(a) Get and make a list file describing a path and an FF that are to be a Critical Path and Input the List File to a Delay Fault Simulator.

(b) Draw the information of a path and an FF that are to be a critical path from the other timing analysis tool and the like and input it to a delay simulator.

(c) Store a path and an FF that are to be a critical path in advance and make a delay fault simulator recognize the same circuit.

2. Clock Line

A clock line means a signal for controlling a timing when a memory device (flip-flop and latch gate) stores a signal and, as shown in FIG. 28, the memory device (hereinafter referred to as “FF”) is controlled by a clock signal that is the base of operation of an LSI. When a timing when the signal is propagated to the data input terminal of the FF and a timing when the signal is stored change, the LSI is not operated normally. Therefore, a delay fault is generated for the data input terminal of the FF to which such a clock signal is inputted.

A method of recognizing the FF and the clock line is inputted by the techniques described below. Further, the method for recognizing may be inputted by any one of the techniques, so it is not specified.

(a) Get and make a list file describing a path and an FF that are to be a clock line and input the list file to a delay fault simulator.

(b) Draw the information of a path and an FF that are to be a clock line from the other timing analysis tool and the like and input it to a delay simulator.

(c) Store a path and an FF that are to be a clock line advance and make a delay fault simulator recognize the same circuit.

3. Others

In addition, only a signal path for which a timing is to be taken into account, a gate, a reset signal, and a setup signal are verified.

4. Overlapping Faults

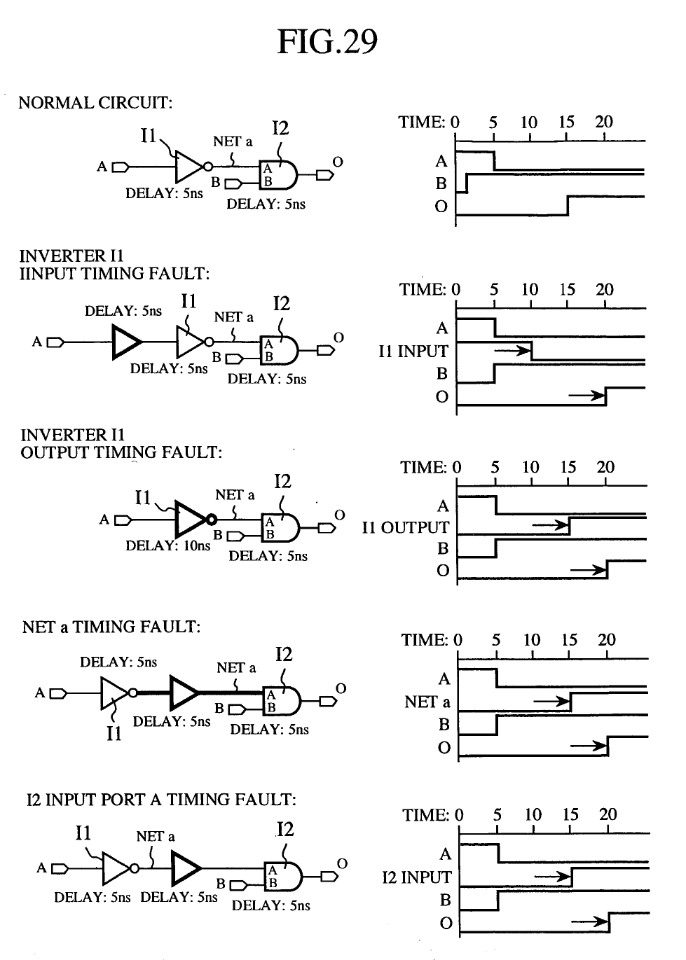

FIG. 29 shows examples of an equivalent fault of a timing fault and there are cases where one path and a gate and net before and after the path cause the same delay fault. In such a delay fault, it is only essential to check one arbitrary typical delay fault and hence it is possible eliminate unnecessary delay faults and to check only one typical arbitrary delay fault. Incidentally, FIG. 29 shows the cases where delay increases: in a normal circuit shown in the uppermost figure, an inverter I1 having a self-delay of 5 ns is connected to the input port A of an AND gate; in the figure next to the uppermost figure, a delay fault of 5 ns is caused at the input port A; in the middle figure, a delay fault of 5 ns is caused at the inverter I1 itself; in the figure next to the lowest figure, a delay fault of 5 ns is caused at a net a; and in the lowest figure, a delay fault of 5 ns is caused at the input port A of the AND gate. In this manner, the delay fault of 5 ns caused at the output port of the inverter gate I1 and the delay fault of 5 ns caused at the input port of the inverter gate I1 produce the same results. Similarly, the delay fault of 5 ns caused at the input port A of the AND gate and the delay fault of 5 ns caused at the net produce the same results, too (see the third and fourth figures from the lowest figure). Therefore, as to these delay faults producing the same results, it is recommended to check any one of such delay faults.

According to the present preferred embodiment 2, a delay fault is distributed at a specified gate among the gates and nodes included in a semiconductor circuit. Therefore, it is possible to reduce a verification time drastically and thus speed up a verifying operation in fault verification.

Embodiment 3

An embodiment 3 of the present invention is characterized by a delay fault analysis of locating a fault point caused by a delay fault by drawing the information of a detecting time of a delay fault, a detecting pin, a detected value, a fault point, an abnormal delay value from the fault verification apparatus in accordance with the embodiments 1 and 2 described above.

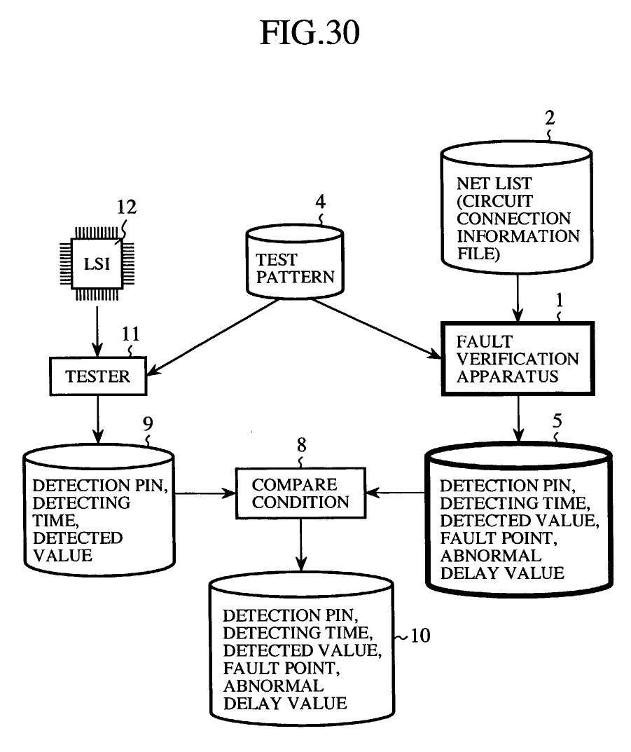

FIG. 30 is an illustration of a technique of analyzing a delay fault in accordance with the preferred embodiment 3 of the present invention. In FIG. 30, reference numeral 1 denotes a fault verification apparatus that checks the quality of a test pattern and checks a delay fault; numeral 2 denotes a net list that is the logic connection information of an LSI circuit that is inputted to the fault verification apparatus 1; numeral 4 denotes a test pattern that is input information for operating the LSI circuit; numeral 5 denotes a fault detection report file including information such as detection pin, detecting time, detected value, fault point and abnormal delay value which is obtained from the fault simulation performed by the fault verification apparatus 1; numeral 12 denotes a semiconductor circuit such as an LSI and the like; numeral I1 denotes a tester; numeral 9 denotes a detection state report file including information obtained by various kinds of circuit tests of the tester I1 such as detection pin, detecting time, detected value and the like; numeral 8 denotes a condition comparing section for comparing the predetermined conditions; and numeral 10 denotes a comparison result file including the results obtained by comparing the conditions of the detection pin, detection time, detected value, fault point, and abnormal delay value by the condition comparing section.

Next, the operation flow of this fault analysis technique will be described.

The fault verification apparatus 1 receives the logic connection information of the LSI circuit from the net list 2 and performs fault simulations by use of various kinds of fault types on the basis of the test pattern 4 and compares the results of the fault simulations with those of a normal circuit and then stores the comparison results in the fault detection report file 5. On the other hand, the tester I1 judges the pass or fail of an LSI circuit 12 on the basis of the test pattern 4 in the same manner and stores the judgment results in the detection state report file 9. The condition comparing section 8 compares the conditions of the detection pin, detecting time, detected value, fault point, abnormal delay value between the fault detection report file 5 and the detection state report file 9 to thereby analyze a fault point caused by the delay fault and stores the analysis results in the comparison result file 10.

Hereinafter, a technique of analyzing a delay fault that locates the fault point of the LSI circuit 12 caused by the delay fault by use of the verification results of the fault verification apparatus 1 of delay will be described.

1. Specifying a Fault Point

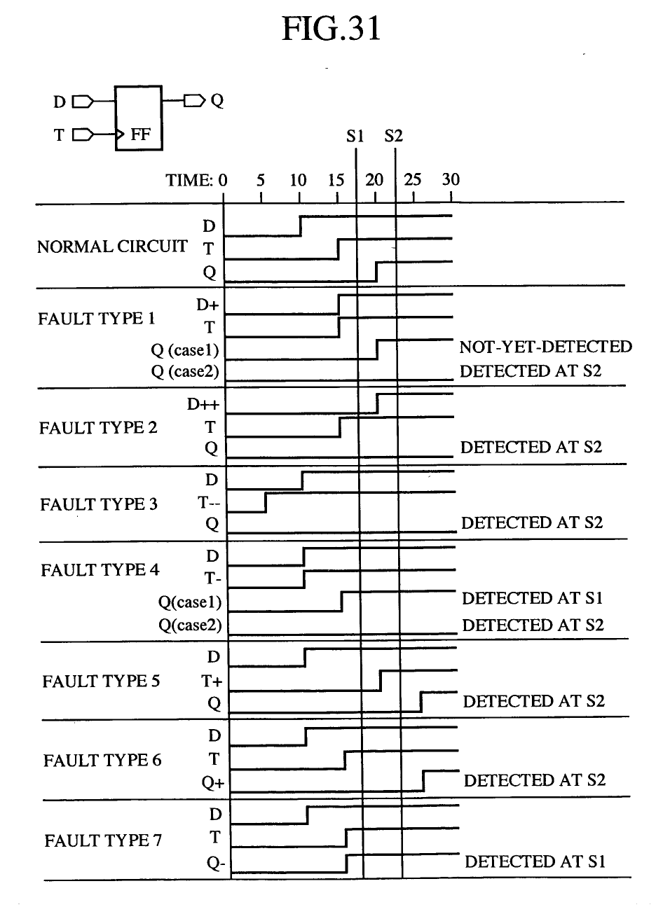

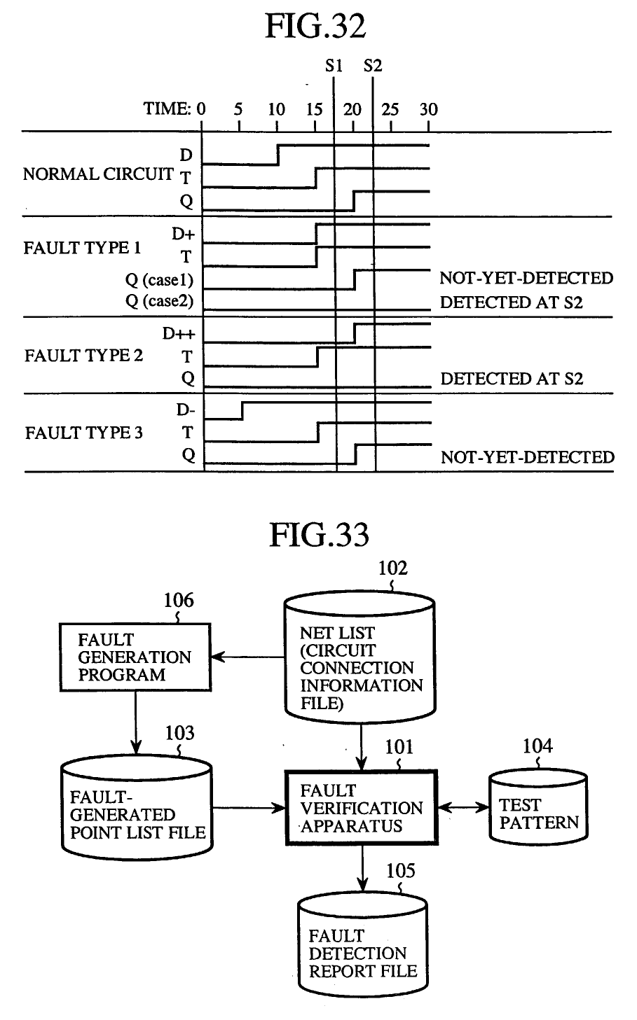

A point where a delay fault is caused is located by the results of the fault simulation taking into account the delay fault of the embodiment 1. As shown in the checking example 1 shown in FIG. 31, it is the fault of a fault type 4, in which the clock input T is advanced by 5 ns in propagation as compared with a normal circuit, and the fault of a fault type 7, in which a delay fault is caused at the output Q and is outputted by 5 ns earlier than in the normal circuit, that can be detected at the expected value comparing time of the flip-flop S1. From this result, it is clear that the faults caused by a delay abnormality are at the clock input T or the output Q. Incidentally, in the timing chart of FIG. 31, reference symbols S1 and S2 denote the comparison points of the expected values; pin name+denotes a normal delay of+5 time unit; pin name++denotes a normal delay of+10 time unit; a pin name−denotes a normal delay of−5 time unit; and a pin name—denotes a normal delay of−10 time unit, and ditto for FIG. 32.

2. Checking of Width of Delay to be Detected

From the results of the fault simulation of the embodiment 1 in which the delay fault is taken into account, it is possible to check the width of delay to be detected of the delay fault. As is evident from the checking example 2 shown in FIG. 32, it is possible to detect a delay fault that is caused at a data input D and is not smaller than 5 ns, but it is impossible to detect a delay fault of smaller than 5 ns. Further, it is possible to analyze (check) a delay margin up to causing a delay fault.

As described above, according to the present preferred embodiment 3, from the results of the fault simulation of the embodiments 1 and 2 in which the delay fault is taken into account, it is possible to locate or specify a point where a delay fault is caused and, in addition, to check the width of delay to be detected of the delay fault.

What is claimed is:

1. A fault verification apparatus:
means for inputting circuit information of a semiconductor circuit and for drawing a fault point;
means for performing a logic simulation through a normal circuit by use of a test pattern and for defining the simulation results as a first expected value;
means for specifying a fault-generated point from said fault point and for generating a predetermined delay fault and for inserting the delay fault at said fault-generated point to produce a fault circuit;
means for performing a logic simulation through said fault circuit by use of said test pattern and for defining the simulation results as a second expected value; and
means for comparing the first expected value through the normal circuit with the second expected value through the fault circuit at a specific time.

2. The fault verification apparatus according to claim 1, wherein the specific time is specified at least at one point.

3. The fault verification apparatus according to claim 1, wherein the delay in the predetermined delay fault is increased or decreased by a specific amount of change of delay within a predetermined range.

4. The fault verification apparatus according to claim 1, wherein the generation of the delay fault is distributed at a gate and a node.

5. The fault verification apparatus according to claim 1, wherein the comparing means checks that if the first expected value is different in comparison results from the second expected value, the test pattern can detect the delay abnormality of the circuit.

6. The fault verification apparatus according to claim 1, wherein the delay fault is inserted into a critical path and a clock line of the semiconductor circuit.
